(19) United States
(12) Patent Application Publication
(10) Pub. No.: US 2007/0047042 A1
(43) Pub. Date: Mar. 1, 2007

(54) Hologram recording apparatus and hologram recording method

(75) Inventor: Tatsumi Noguchi, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/506,775

(22) Filed: Aug. 21, 2006

(30) Foreign Application Priority Data
Aug. 30, 2005 (JP) 2005-249082

(51) Int. Cl. G03H 1/28

(52) U.S. Cl. 359/24; 359/21

(57) ABSTRACT

A hologram recording method and a hologram recording apparatus are provided. A hologram recording apparatus which forms information into element holograms for recording, includes: data page generating means for forming a two-dimensional matrix from a linear information sequence that is an encoding target and generate a data page; inner page encoding means for conducting encoding that is completed in the data page to generate an inner encoded page; interpage encoding means for conducting encoding over the inner encoded pages to generate an outer encoded page; and element hologram matrix generating means for forming the outer encoded page into a 2D code symbol, generating a physical page including the 2D code symbol, and continuously forming the physical page into element holograms to generate an element hologram matrix.

### CROSS REFERENCES TO RELATED APPLICATIONS

The present invention contains subject matter related to Japanese Patent Application JP 2005-249082 filed in the Japanese Patent Office on Aug. 30, 2005, the entire contents of which being incorporated herein by reference.

### BACKGROUND OF THE INVENTION

1. Field of the Invention

The present invention relates to a hologram recording apparatus and a hologram recording method, in which an encoding process is conducted for audio information such as sound or music, image information such as a still image or a moving image, or information such as a text file and then the information is recorded on a hologram recording medium in a sheet shape, for example, as a plurality of element holograms, particularly to an information encoding scheme of a hologram recording apparatus and a hologram recording method.

2. Description of the Related Art

Patent Reference 1: Japanese Patent No. 2833975

For an exemplary scheme to record information on a recording medium in a sheet shape, a linear code or a two-dimensional code is named, typified by a bar code, a QR code, dot code, etc. However, these information recording media have about a few tens to a few kilobytes of an information amount capable of recording per unit area, which is very low. This is because the recording resolution of simple grayscale printing of an image has physical limitations.

In addition, for a similar recording medium in a sheet shape, a hologram recording medium is also known which records various items of data with interference fringes of object beams and reference beams. It is also known that the hologram recording medium dramatically improves recording density to allow a significant increase in capacity. For example, it is considered to be useful as a large capacity storage medium for computer data and AV (Audio-visual) contents data such as audio and video.

In recording data on the hologram recording medium, data is imaged as two-dimensional page data. Then, the imaged data is displayed on a liquid crystal panel, for example, the light transmitted through the liquid crystal panel is object beams, that is, the object beams to be an image of two-dimensional page data, and the beams are applied onto the hologram recording medium. In addition to this, reference beams are applied onto the hologram recording medium at a predetermined angle. At this time, interference fringes generated by the object beams and the reference beams are recorded as a single element hologram in a strap or in a dot. In other words, a single element hologram is what records a single item of two-dimensional page data.

### SUMMARY OF THE INVENTION

For example, a hologram memory in a sheet shape is considered, and a system is considered in which computer data and AV contents data are recorded and general users use a reconstruction apparatus as a hologram reader to acquire data recorded on a hologram memory.

The hologram memory in a sheet shape is a memory that records a plurality of element holograms on the plane as the surface of a medium as though the element holograms are paved thereon, in which the hologram reader is faced to the surface of the medium to read the recorded data as the individual element holograms.

When hologram technology is used, an amount of information per unit area for recording can be improved dramatically as compared with normal printing. However, the information encoding scheme used for the bar code or QR code scheme has the purpose of recording information on normal two-dimensional printing media, which has no consideration for applications to hologram recording.

It is desirable to provide an encoding scheme preferable for information recording on a hologram recording medium, particularly to provide an information encoding scheme preferable for recording a large amount of information on a medium in a sheet shape, on which so-called holograms are printed.

A hologram recording apparatus according to an embodiment of the invention is a hologram recording apparatus which forms information into element holograms for recording, including: data page generating means for forming a two-dimensional matrix from a linear information sequence that is an encoding target and generates a data page; inner page encoding means for conducting encoding that is completed in the data page to generate an inner encoded page; interpage encoding means for conducting encoding over the inner encoded pages to generate an outer encoded page; and element hologram matrix generating means for forming the outer encoded page into a 2D code symbol, generating a physical page including the 2D code symbol, and continuously forming the physical page into element holograms to generate an element hologram matrix.

In addition, the data page generating means conducts: a raw page creation process which forms a two-dimensional matrix from a linear information sequence that is an encoding target and generates a raw page; a sector splitting process which splits the raw page into raw sectors that are units of error detection; an error detecting code adding process which adds an error detecting code to the raw sector to form sectors with error detecting codes; a scramble process which scrambles the sectors with error detecting codes to generate scrambled data sectors; and a page joining process which joins the scrambled data sectors to generate a scrambled data page to output the scrambled data page as a data page.

In addition, the inner page encoding means conducts: a data array transform process which transforms the data page outputted from the data page generating means to an arrangement that allows multidimensional encoding and generates an information data block; an inner page encoding process which performs multidimensional encoding for the information data block to generate a code data block; an inner page interleave process which rearranges the inside of the code data block in accordance with a predetermined rule to generate an interleaved code data block; and a data array inverse transform process which transforms the interleaved code data block to a page arrangement equivalent to the data page to generate an inner encoded page.

In addition, the interpage encoding means conducts: a page arrangement transform process which transforms the inner encoded page outputted from the inner page encoding means to a page arrangement that allows interpage encoding and generates an information page block; an interpage encoding process which performs interpage encoding for the information page block to generate a code page block; a page duplication process which duplicates the code page block to multiple blocks to generate duplicated page blocks; an interpage interleave process which rearranges the duplicated page blocks in accordance with a predetermined rule to generate interleaved duplicated blocks; and a page arrangement retransform process which transforms the interleaved duplicated blocks to a page arrangement equivalent to the inner encoded page to generate an outer encoded page.

In addition, the element hologram matrix generating means conducts: a first two-dimensional modification process which two-dimensionally modifies the outer encoded page outputted from the interpage encoding means to generate a two-dimensional code symbol; a page ID creation process which generates a logical page ID for the inner encoded page and generates a physical page ID for the outer encoded page; a page ID encoding process which adds an error correction parity to the logical page ID and the physical page ID to generate a logical page ID code and a physical page ID code; a second two-dimensional modification process which two-dimensionally modifies the logical page ID code and the physical page ID code to generate a logical page ID code symbol and a physical page ID code symbol; a synchronization signal creation process which creates a main sync symbol; a crosstalk detect symbol creation process which creates a crosstalk detect symbol that detects crosstalk between adjacent element holograms; a page search symbol creation process which joins the logical page code symbol, the physical page code symbol, the main sync symbols and the crosstalk detect symbol to one another to generate a page search symbol; a physical page creation process which joins the two-dimensional code symbol to the page search symbol to generate a physical page; and an element hologram matrixing process which continuously forms the physical pages into element holograms to form an element hologram matrix.

A hologram recording method according to an embodiment of the invention includes the steps of: forming a two-dimensional matrix from a linear information sequence that is an encoding target and generating a data page; conducting encoding that is completed in the data page and generating an inner encoded page; conducting encoding over the inner encoded pages to generate an outer encoded page; and forming the outer encoded page into a two-dimensional code symbol, generates a physical page including the two-dimensional code symbol, and continuously forming the physical page into element holograms to generate an element hologram matrix.

More specifically, according to an embodiment of the invention, a data page is generated from a linear information sequence that is an encoding target, and inner encoding and outer encoding are conducted for the data page. Then, after outer encoding, a physical page as two-dimensional data is generated from the data to form the physical page into an element hologram matrix.

According to an embodiment of the invention, the data page is generated from the linear information sequence that is an encoding target, inner encoding (inner page encoding) and outer encoding (interpage encoding) are conducted for the data page to generate the physical page as two-dimensional data, and the physical page is formed into the element hologram matrix, whereby an encoding scheme can be implemented which is preferable for information recording on a hologram recording medium.

Particularly, in the data page creation process, data to be element holograms is split into sectors to add the error detecting code thereto, whereby the reliability of finally corrected data can be determined in units of sectors.

In addition, the scramble process is conducted for the sectors added with the error detecting codes. More specifically, the logical page is scrambled. When this is done, the descriptions of the recorded data cannot be read easily from the physical page optically read in reconstruction. Therefore, it is preferable in view of the security and copyright protection of contents data and computer data to be recorded on a hologram recording medium.

In addition, in the inner page encoding process, an error correcting code is added in units of the logical pages. Therefore, error detection and correction can be done in units of the logical pages.

In addition, the interleave process which is completed inside the logical page is conducted to distribute symbol error caused by the intensity fluctuations and geometrical shifts in the physical page throughout the physical page.

In addition, inter page encoding is conduced in the interpage encoding process to eliminate a necessity to read all pages in reading. More specifically, even though all the pages are not read, loss correction is conducted for the unread pages to reproduce all the logical pages. Accordingly, the implementation of efficient scan and improved data read performance in reconstruction can be intended.

In addition, the page duplication process is conducted to allow a closed stack element hologram matrix, and thus the read operation of element holograms can be facilitated.

In addition, in the hologram matrix creation process, the logical page ID uniquely allocated to the inner encoded page and the physical page ID uniquely allocated to the outer encoded page are added, whereby the physical reconstruction position can be first grasped by the physical page ID in reconstruction of the physical page from the element holograms, and the logical reconstruction position can be grasped at which the physical page is developed as the logical page on the memory in the reconstruction apparatus. Accordingly, the conditions to read the element holograms can be properly established.

### BRIEF DESCRIPTION OF THE DRAWINGS

FIGS. 1A and 1B show illustrative diagrams depicting the recording and reconstruction of a hologram memory according to an embodiment of the invention;

FIG. 2 shows an illustrative diagram depicting the configuration and the process of a hologram recording system according to an embodiment;

FIGS. 3A, 3B, 3C and 3D show illustrative diagrams depicting processes done by individual parts of the hologram recording system according to an embodiment;

FIG. 4 shows an illustrative diagram depicting the processes done by a scrambled page data generator according to an embodiment;

FIG. 5 shows an illustrative diagram depicting input data according to an embodiment;

FIG. 6 shows an illustrative diagram depicting a raw page creation process according to an embodiment;

FIG. 7 shows an illustrative diagram depicting a sector splitting process according to an embodiment;

FIG. 8 shows an illustrative diagram depicting raw sectors according to an embodiment;

FIG. 9 shows an illustrative diagram depicting an EDC adding process according to an embodiment;

FIG. 10 shows an illustrative diagram depicting scrambled data sectors according to an embodiment;

FIG. 11 shows an illustrative diagram depicting a page joining process according to an embodiment;

FIG. 12 shows an illustrative diagram depicting scrambled data pages according to an embodiment;

FIG. 13 shows an illustrative diagram depicting processes done by an inner page encoder according to an embodiment;

FIG. 14 shows an illustrative diagram depicting a data array transform process according to an embodiment;

FIG. 15 shows an illustrative diagram depicting an the inner page encoding process according to an embodiment;

FIG. 16 shows an illustrative diagram depicting an inner page interleave process according to an embodiment;

FIG. 17 shows an illustrative diagram depicting inner encoding pages according to an embodiment;

FIG. 18 shows an illustrative diagram depicting processes done by an outer page encoder according to an embodiment;

FIG. 19 shows an illustrative diagram depicting a page arrangement transform process according to an embodiment;

FIG. 20 shows an illustrative diagram depicting an interpage encoding process according to an embodiment;

FIG. 21 shows an illustrative diagram depicting a page duplication process according to an embodiment;

FIG. 22 shows an illustrative diagram depicting an interpage interleave process according to an embodiment;

FIG. 23 shows an illustrative diagram depicting outer encoded pages according to an embodiment;

FIG. 24 shows an illustrative diagram depicting processes done by a hologram unit matrix generator 14 according to an embodiment; the FIG. 25 shows an illustrative diagram depicting two-dimensional code symbol modification according to an embodiment;

FIG. 26 shows an illustrative diagram depicting a two-dimensional code symbol according to an embodiment;

FIG. 27 shows an illustrative diagram depicting two-dimensional code symbols to be excluded according to an embodiment;

FIG. 28 shows an illustrative diagram depicting a two-dimensional modification table according to an embodiment;

FIG. 29 shows an illustrative diagram depicting a two-dimensional modification table according to an embodiment;

FIG. 30 shows an illustrative diagram depicting a two-dimensional modification table according to an embodiment;

FIG. 31 shows an illustrative diagram depicting a two-dimensional modification table according to an embodiment;

FIG. 32 shows an illustrative diagram depicting a two-dimensional modification table according to an embodiment;

FIG. 33 shows an illustrative diagram depicting a two-dimensional modification table according to an embodiment;

FIG. 34 shows an illustrative diagram depicting a two-dimensional modification table according to an embodiment;

FIG. 35 shows an illustrative diagram depicting group R creation according to an embodiment;

FIG. 36 shows an illustrative diagram depicting group sub-sync creation according to an embodiment;

FIG. 37 shows an illustrative diagram depicting a page search symbol according to an embodiment;

FIG. 38 shows an illustrative diagram depicting a group main-sync according to an embodiment;

FIG. 39 shows an illustrative diagram depicting a physical page according to an embodiment;

FIG. 40 shows an illustrative diagram depicting a preamble physical page according to an embodiment;

FIG. 41 shows an illustrative diagram depicting a physical page of increment data according to an embodiment;

FIG. 42 shows an illustrative diagram depicting a physical page of random data according to an embodiment;

FIG. 43 shows an illustrative diagram depicting a physical page of 00h fixed data according to an embodiment;

FIG. 44 shows an illustrative diagram depicting a physical page of FFh fixed data according to an embodiment;

FIG. 45 shows an illustrative diagram depicting a hologram unit matrix according to an embodiment;

FIGS. 46A and 46B show illustrative diagrams depicting main sync symbols according to an embodiment;

FIG. 47 shows an illustrative diagram depicting main sync symbols and reconstruction signals according to an embodiment;

FIG. 48 shows an illustrative diagram depicting a logical page ID code symbol according to an embodiment;

FIG. 49 shows an illustrative diagram depicting a physical page ID code symbol according to an embodiment;

FIGS. 50A and 50B show illustrative diagrams depicting element hologram matrices according to an embodiment;

FIG. 51 shows an illustrative diagram depicting a crosstalk detect symbol according to an embodiment;

FIG. 52 shows an illustrative diagram depicting crosstalk detect symbols in individual numbers according to an embodiment;

FIG. 53 shows an illustrative diagram depicting reconstructed images of crosstalk detect symbols according to an embodiment;

FIG. 54 shows an illustrative diagram depicting reconstructed images of crosstalk detect symbols according to an embodiment;

FIG. 55 shows an illustrative diagram depicting tracking positions according to an embodiment;

FIG. 56 shows an illustrative diagram depicting reconstructed images of crosstalk detect symbols according to an embodiment;

FIG. 57 shows an illustrative diagram depicting reconstructed images of crosstalk detect symbols according to an embodiment;

FIG. 58 shows an illustrative diagram depicting reconstructed images of crosstalk detect symbols according to an embodiment;

FIGS. 59A and 59B show illustrative diagrams depicting tracking positions according to an embodiment;

FIG. 60 shows an illustrative diagram depicting reconstructed images of crosstalk detect symbols according to an embodiment; and

FIG. 61 shows an illustrative diagram depicting reconstructed images of crosstalk detect symbols according to an embodiment.

### DETAILED DESCRIPTION OF THE INVENTION

Hereinafter, an embodiment of the invention will be described in the following order.
1. Recording and reconstruction of a hologram memory
2. Outline of overall data encoding processes
3. Data page creation process
4. Inner page encoding process
5. Interpage encoding process
6. Hologram matrix creation process
7. Advantage of the embodiment
   1. Recording and Reconstruction of a Hologram Memory

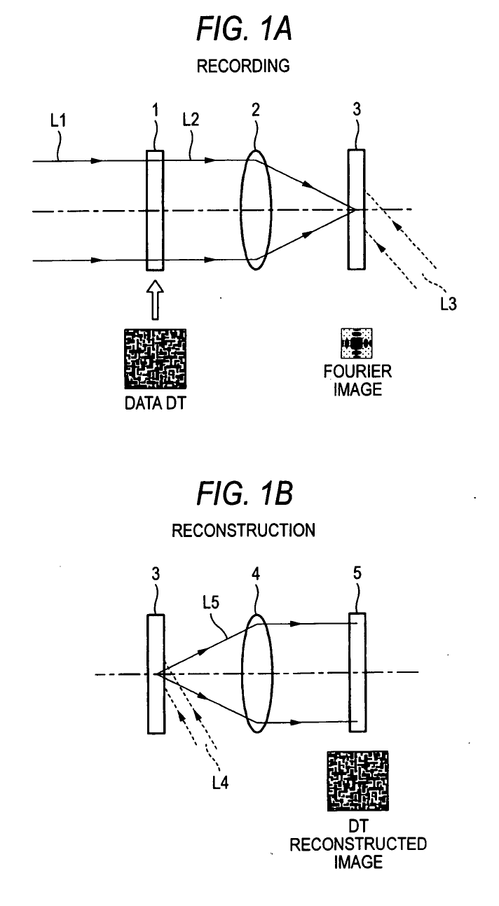

First, the basic operations of recording and reconstruction of a hologram memory 3 will be described with reference to FIGS. 1A and 1B.

FIG. 1A shows a data recording manner for the hologram memory 3. For example, when data such as contents data or data as a computer program is recorded in the hologram memory 3, the entire recorded data is encoded to a plurality of pages of data.

One item of data DT as an encoded unit is converted into image data in a two-dimensional bar code, for example, as shown in the drawing, and is displayed as an image of two-dimensional page data on a liquid crystal panel 1.

Laser beams L1 outputted from a predetermined light source and formed into parallel light beams, for example, pass through the liquid crystal panel 1 on which the image of two-dimensional page data is displayed, and then the beams are turned to object beams L2 as an image of the two-dimensional page data.

The object beams L2 are condensed by a condenser lens 2, and are gathered as a spot on the hologram memory 3.

At this time, onto the hologram memory 3, record reference beams L3 are applied at a predetermined angle. Thus, the object beams L2 interfere with the reference beams L3, and an element hologram in dots is recorded by interference fringes thereof.

In addition, as described above, when the condenser lens 2 is used, data recorded as the element hologram is a Fourier image of an image of the recorded data due to the effect of Fourier transform by the condenser lens 2.

As described above, a single element hologram is recorded on the hologram memory 3. Data DT of an encode unit is sequentially converted into two-dimensional page data in the similar manner, displayed on the liquid crystal panel 1, and recorded as an element hologram one by one.

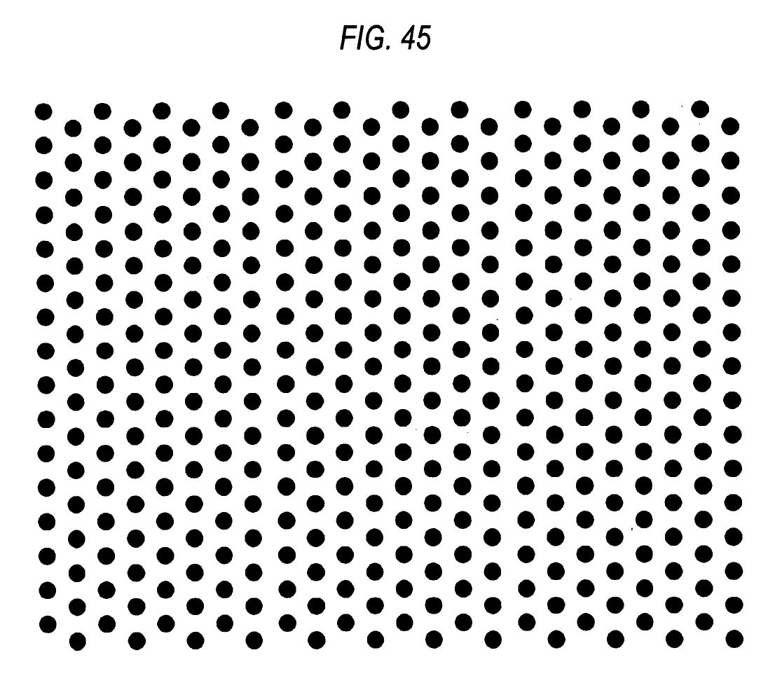

In recording each of the element holograms, the position of the hologram memory 3 (hologram material) is moved by a transport mechanism, not shown, (or a recording optical system is moved) , the recording position of the element holograms is slightly shifted on the plane of the hologram memory 3. Thus, recording is conducted such a way that a plurality of element holograms are arranged on the hologram memory 3 in a sheet shape, for example, in the plane direction. For example, in FIG. 45, a single element hologram is depicted by a black circle. In this manner, a plurality of element holograms are formed on the plane.

For the hologram memory 3 on which the element holograms are thus recorded, reconstruction is performed as described in FIG. 1B. A collimator lens 4 and an imager 5 shown in FIG. 1B are configured to be provided in a reconstruction apparatus as a hologram reader.

Onto the hologram memory 3, reconstruction reference beams L4 are applied at the same application angle as that in recording. When the reconstruction reference beams L4 are applied, a reconstructed image can be obtained that is recorded as the element holograms. In other words, an image of two-dimensional page data appears at the place conjugated with the liquid crystal panel 1 when recorded. It is sufficient to read the image by the imager 5.

More specifically, reconstructed image beams L5 from the hologram memory 3 are formed into parallel light beams by the collimator lens 4, and enter the imager 5 formed of a CCD imaging device array or a CMOS imaging device array, for example. The Fourier image on the hologram memory 3 is transformed in inverse Fourier transform by the collimator lens 4, and formed into an image of two-dimensional page data. Thus, the reconstructed image as the image of two-dimensional page data is read by the imager 5.

The imager 5 generates a reconstructed image signal as an electrical signal in accordance with the reconstructed image. A decoding process is conducted for the reconstructed image signal, whereby original data is obtained, that is, data before converted to the two-dimensional page data for the purpose of recording.

A plurality of the element holograms on the hologram memory 3 is similarly, continuously read, whereby the recorded original contents data can be reproduced.

In addition, for a recording scheme for the hologram memory 3 like this, angle multiplexing recording is known. Angle multiplexing is a scheme that the angle of the record reference beams L3 is varied to record element holograms at the same positions on the plane in a multiplexed manner.

For example, when a single element hologram is recorded as shown in FIG. 1A and then the application angle of the record reference beams L3 is varied, another element hologram can be recorded at the same position on the plane of the hologram memory 3.

In other words, multiplexed recording can be performed using the plane of the hologram memory 3 as multiple planes by varying the angle of the record reference beams L3, whereby the recording capacity can be increased greatly. For example, it is an image that the element hologram matrix plane as shown in FIG. 45 is formed on a large number of planes.

In the reconstruction of the recorded hologram memory 3 after angle multiplexing recording, it is sufficient that the reconstruction reference beams L4 are applied at the same angle as each angle of the record reference beams when recorded. More specifically, the element hologram that is recorded by applying the record reference beams L3 at a first angle can be read by applying the reconstruction reference beams L4 at the same first angle, and the element hologram that is recorded by applying the record reference beams L3 at a second angle can be read by applying the reconstruction reference beams L4 at the same second angle.

In addition, the hologram memory 3 on which data is recoded with element holograms described above can be easily copied in mass production by contact copy.

Therefore, the hologram memory 3 on which element holograms are recorded on a hologram material as shown in FIG. 1A may be formed as a hologram memory to be offered as it is for general users. Alternatively, the memory may be a master medium for use in mass production of copies of a hologram memory.

For example, when such a system is considered that computer data or AV contents data is recorded on a hologram recording medium for wide distribution as well as a general user uses a reconstruction apparatus (a hologram reader 20) to acquire data recorded on the hologram memory 3, a hologram master medium is created as shown in FIG. 1A, a hologram memory copied from that master medium is distributed, and data is read on the user side by the operation shown in FIG. 1B.

2. Outline of Overall Data Encoding Processes

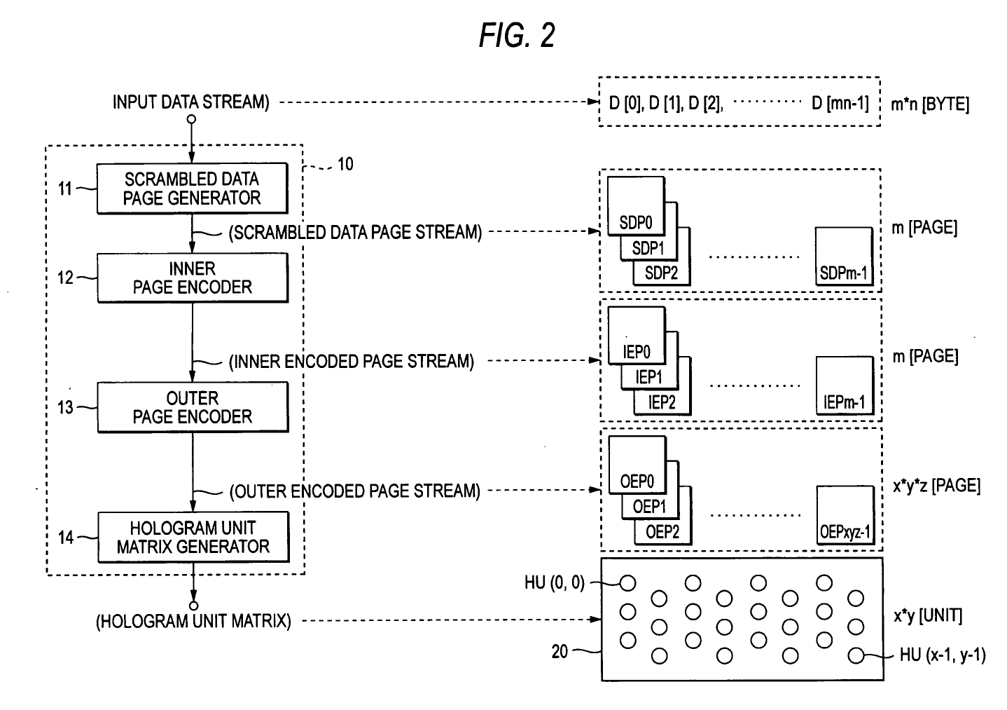

Hereinafter, data encoding processes for recording data on the hologram memory 3 will be described. FIG. 2 shows the configuration of a recording system and the manner of the encoding process in each part.

An input data stream shown in FIG. 2 is the stream data of original data (input data) to be recorded on the hologram memory 3.

For input data, various items of data can be considered such as audio contents, video contents, computer programs or computer data.

A recording system 10 is configured to have a scrambled data page generator 11 which conducts a data page creation process for input data supplied as a record target, an inner page encoder 12 which conducts an inner page encoding process, an outer page encoder 13 which conducts an interpage encoding process, and a the hologram unit matrix generator 14 which conducts a hologram matrix creation process to create a hologram memory 3.

The input data to be target data for encoding has the size of m×n bytes as a unit. Each item of input data in a unit of m×n bytes is expressed by D[0], D[1], . . . , D[mn−1], where m is the number of pages of data for encoding, and n is the number of items of data per page.

The input data is inputted to the scrambled data page generator 11. The scrambled data page generator 11 conducts a scramble process for the input data, and creates m pages of data, scrambled data pages SDP0, SDP1, . . . , SDPm−1. Then, it outputs them as a scrambled data page stream.

The scrambled data pages SDP0, SDP1, . . . , SDPm−1 are inputted to the inner page encoder 12. The inner page encoder 12 conducts the inner page encoding process for the inputted scrambled data pages, and creates m pages of data, inner encoded pages IEP0, IEP1, . . . , IEPm−1. Then, it outputs them as an inner encoded page stream.

The stream data of the inner encoded pages IEP0, IEP1, IEPm−1 is inputted to the outer page encoder 13. The outer page encoder 13 conducts the interpage encoding process for the inputted inner encoded pages, and creates x·y·z pages of data, outer encoded pages OEP0, OEP1, . . . , OEPxyz−1. Then, it outputs them as an outer encoded page stream.

The stream data of the outer encoded pages OEP0, OEP1, OEPxyz−1 is inputted to the hologram unit matrix generator 14. The hologram unit matrix generator 14 conducts an element hologram process for the outer encoded pages, and creates a hologram unit matrix 20 having an xy unit of element holograms HU (0, 0), . . . , HU (x−1, y−1) recorded. The hologram unit matrix is a matrix that element holograms are recorded on a hologram material in the operation shown in FIG. 1A. It may be the hologram memory 3 itself, or may be a master medium for copying the hologram memory 3.

In the specification, the hologram unit matrix 20 is used as a general term meaning that a plurality of element holograms (=hologram units) is arranged on a hologram material.

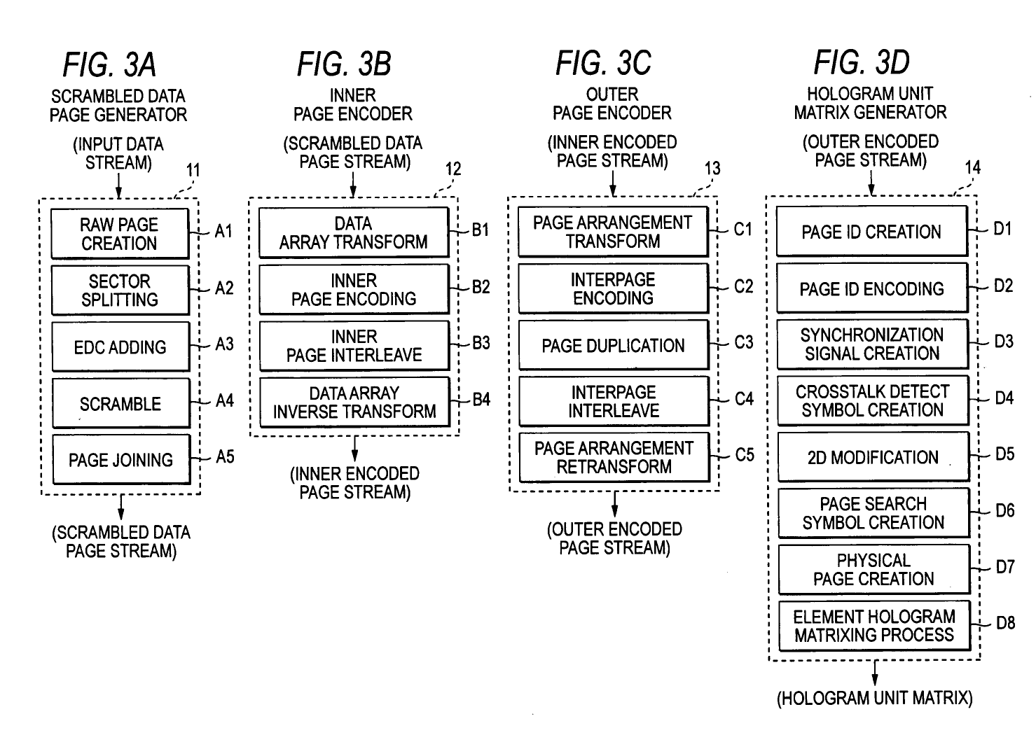

FIGS. 3A, 3B, 3C and 3D show process steps done by each part.

FIG. 3A shows the processes done by the scrambled data page generator 11. In the scrambled data page generator, a raw page creation process A1, a sector splitting process A2, an EDC adding process A3, a scramble process A4, and a page joining process A5 are sequentially conducted to output a scrambled data page stream.

FIG. 3B shows the processes done by the inner page encoder 12. In the inner page encoder 12, a data array transform process B1, an inner page encoding process B2, an inner page interleave process B3, and a data array inverse transform process B4 are sequentially conducted to output an inner encoded page stream.

FIG. 3C shows the processes done by the outer page encoder 13. In the outer page encoder 13, a page arrangement transform process C1, an interpage encoding process C2, a page duplication process C3, an interpage interleave process C4, and a page arrangement retransform process C5 are sequentially conducted to output an outer encoded page stream.

FIG. 3D shows the processes done by the hologram unit matrix generator 14. In the hologram unit matrix generator 14, a page ID creation process D1, a page ID encoding process D2, a synchronization signal creation process D3, a crosstalk detect symbol creation process D4, first and second two-dimensional modification processes D5 and D6, apage search symbol creation process D7, a physical page creation process D8, and an element hologram matrixing process D9 are conducted, element holograms are recorded as described in FIG. 1, and the hologram unit matrix 20 is created.

3. Data Page Creation Process

The data page creation process in the scrambled data page generator 11 will be described in detail.

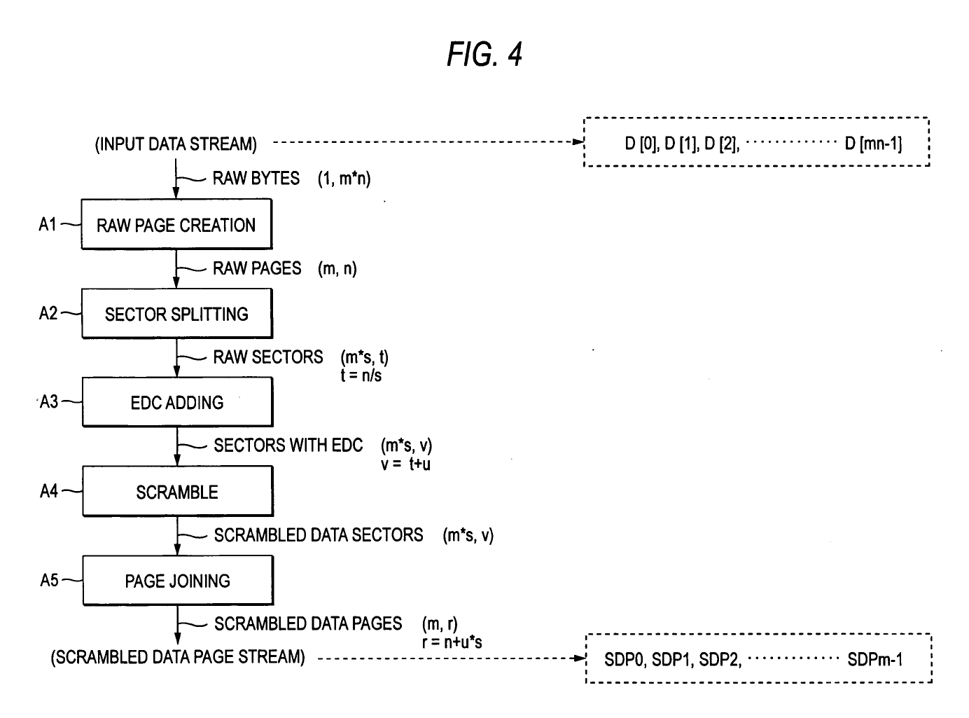

FIG. 4 shows the processes A1 to A5 done by the scrambled data page generator 11 shown in FIG. 3A above.

The raw page creation process A1 is conducted for the input data to create raw pages.

In the sector splitting process A2, raw sectors are created from the raw pages.

In the EDC adding process A3, sectors with EDC are created from the raw sectors.

In the scramble process A4, scrambled data sectors are created from the sectors with EDC.

In the page joining process A5, scrambled data pages are created from the scrambled data sectors.

Each of the processes will be described sequentially.

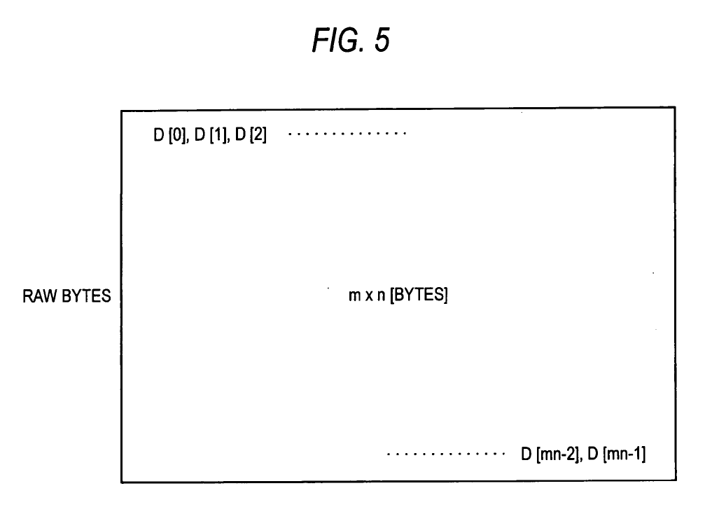

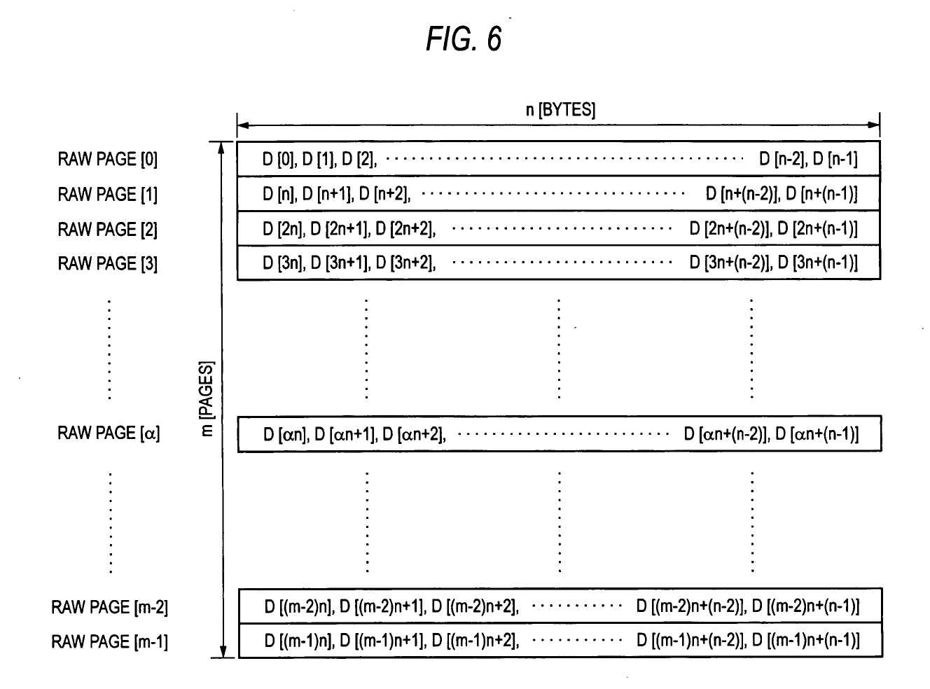

First, the raw page creation process A1 is conducted for raw bytes as input data D[0], D[1], . . . , D[mn−1]]. The raw bytes mean data before processed. As shown in FIG. 5, input data (raw bytes) is configured of a group of m×n items of data. In the raw page creation process A1, a group of data as raw bytes is sequentially split into a data sequence having a unit of n bytes, and raw pages are created as shown in FIG. 6. As shown in the drawing, m pages of raw pages, Raw Page [0], Raw Page [1], . . . , Raw Page [m−1] are created. For example, the raw page, Raw Page [0] is formed of n bytes of input data D[0], . . . , D[n−1]. The other raw pages are n bytes each.

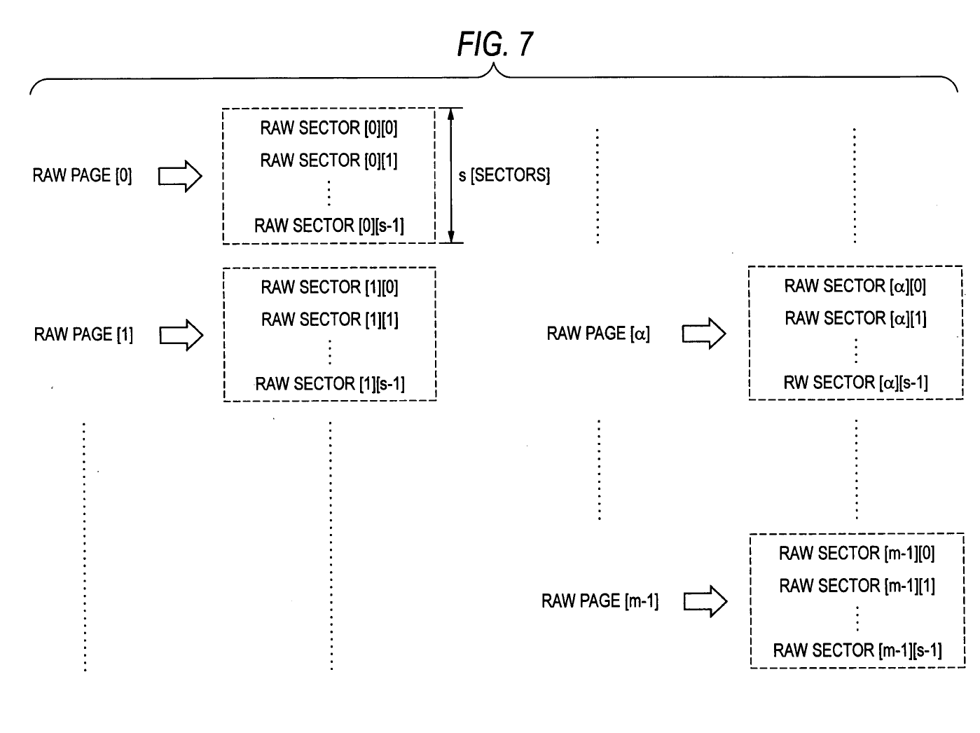

Subsequently, in the sector splitting process A2, each of the raw pages, Raw Page [0], Raw Page [1], . . . , Raw Page [m−1] is split into s sectors of raw sectors. More specifically, as shown in FIG. 7, the raw page Raw Page [0] is split into s sectors of raw sectors, Raw Sector [0] [0], Raw Sector [0] [1], . . . , Raw Sector [0] [s−1]. Similarly, the raw page Raw Page [1] is split into s sectors of raw sectors, Raw Sector [1] [0], Raw Sector [1] [1], . . . , Raw Sector [1] [s−1]. The process steps are similar to the raw page Raw Page [m−1].

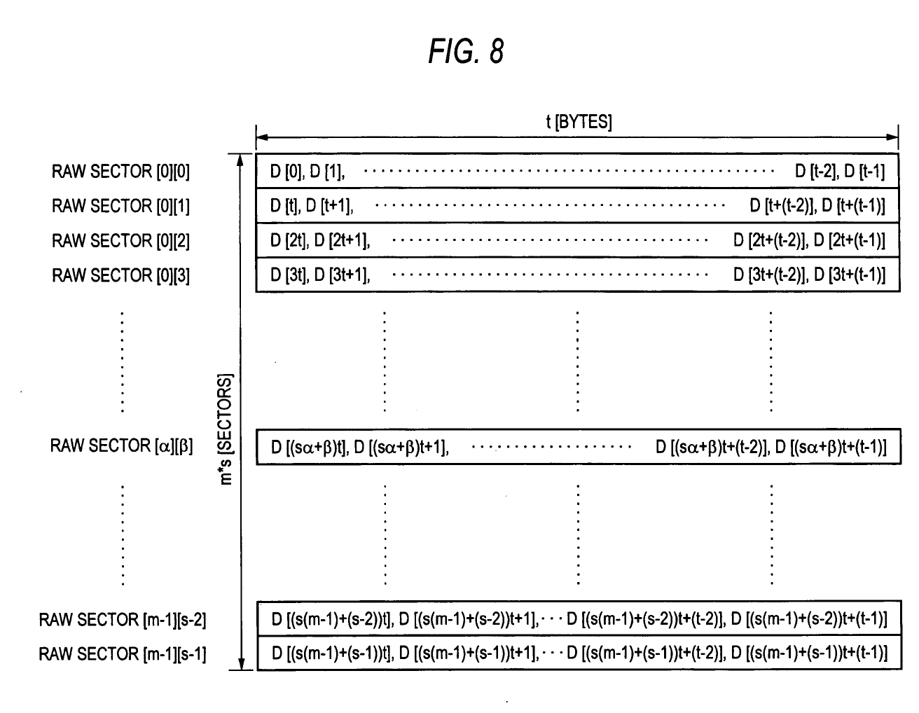

All the raw pages are each split into s sectors of raw sectors, and thus m×s sectors of raw sectors, Raw Sector [0] [0], . . . , Raw Sector [m−1] [s−1] are formed, which are shown in FIG. 8. In FIG. 8, the configuration of each of the raw sectors, Raw Sector [0] [0], . . . , Raw Sector [m−1][s−1] is represented by input data.

The raw sector is a processing unit of an EDC (error detecting code), described later, and it is configured of t bytes (t=n/s). For example, the raw page Raw Page [0] is formed of t bytes of input data D[0], . . . , D[t−1].

Subsequently, in the EDC adding process A3, the EDC (error detecting code) is added to each of the raw sectors, Raw Sector [0][0], . . . , Raw Sector [m−1] [s−1].

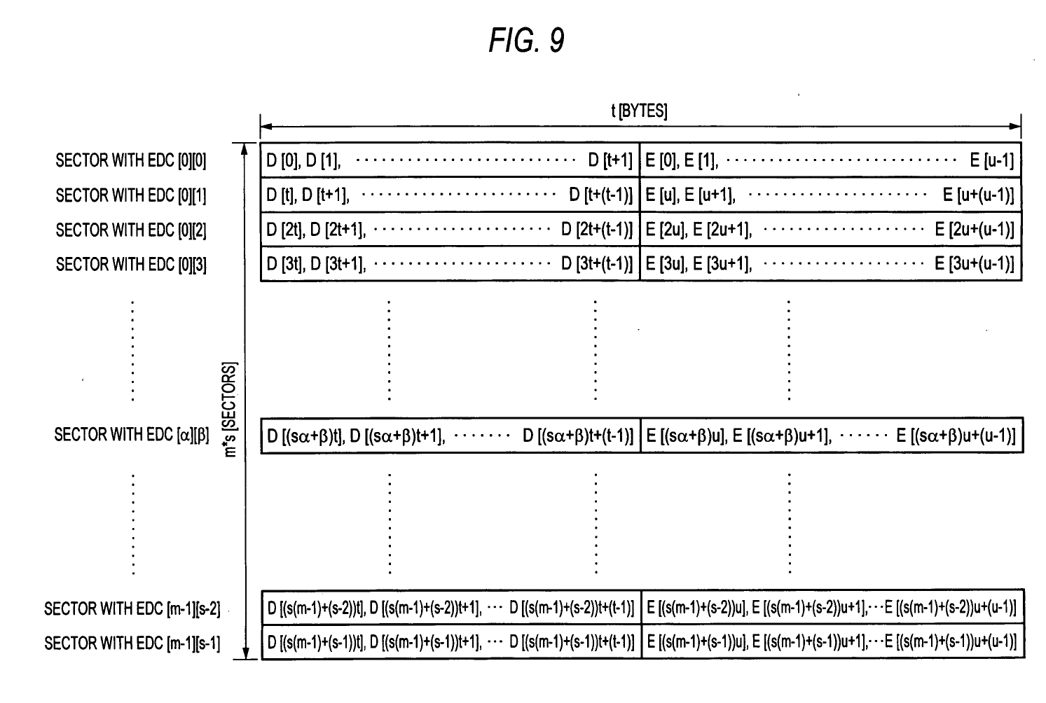

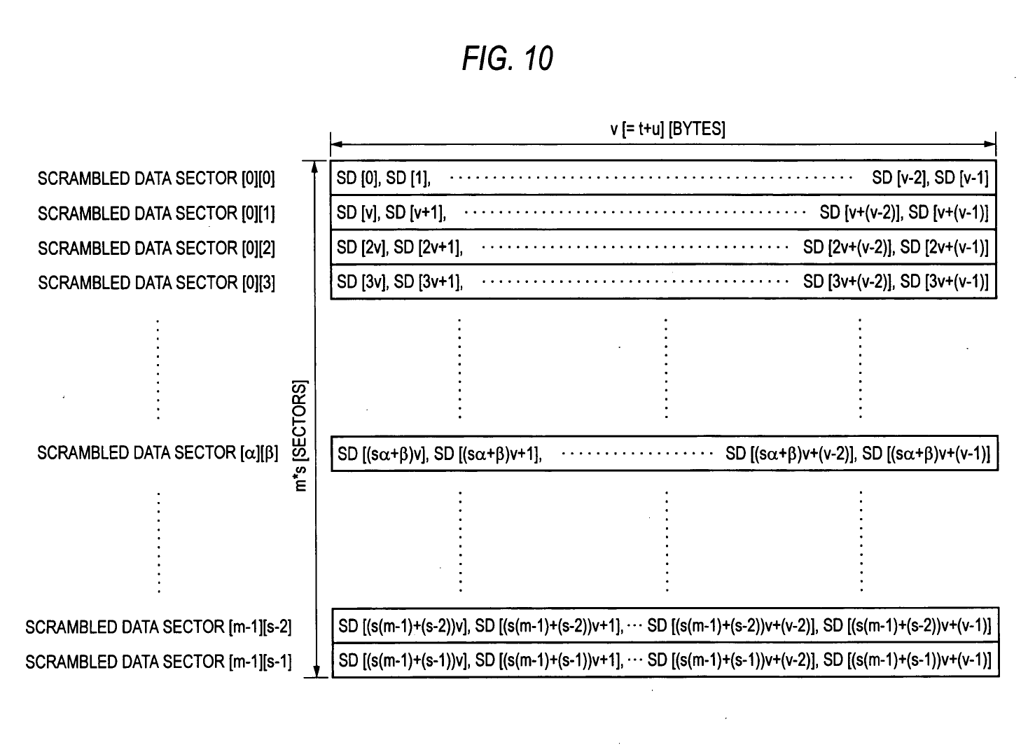

FIG. 9 shows the configuration when u bytes of an EDC (error detecting code) is added to each of the raw sectors. For example, for the raw sector Raw Sector [0] [0], u bytes of EDC parities E[0], E[1], . . . , E[u−1] are added to t bytes of input data D[0], . . . , D[t−1], and this is a sector with EDC [0] [0]. Similarly, the EDC parities are added to the other raw sectors as well. Thus, m×s of sectors with EDC, Sector with EDC [0] [0], Sector with EDC [0] [1], . . . , Sector with EDC [m−1] [s−1] are formed.

Subsequently, in the scramble process A4, the scramble process is conducted for each of the sectors with EDC, Sector with EDC [0] [0], Sector with EDC [0] [1], . . . , Sector with EDC [m−1] [s−1], and scrambled data sectors shown in FIG. 10 are formed.

As apparent from FIGS. 9 and 10, the byte data of each of the sectors with EDC is converted into byte data SD after scrambled.

For example, input data D[0], . . . , D[t−1] and the EDC parities E[0], E[1], . . . , E[u−1] configuring the sector with EDC Sector with EDC [0] [0] in FIG. 9 are scrambled to form the scrambled data sector Scrambled Data Sector [0] [0] formed of byte data SD[0], SD[1], . . . , SD[v−1] shown in FIG. 10. In addition, v bytes forming the scrambled data sector is the number of bytes, (t+u) bytes that configures the sector with EDC.

The other sectors with EDC also undergo the scramble process. Therefore, m×s of the scrambled data sectors, Scrambled Data Sector [0] [0], Scrambled Data Sector [0] [1], Scrambled Data Sector [m−1] [s−1] are formed.

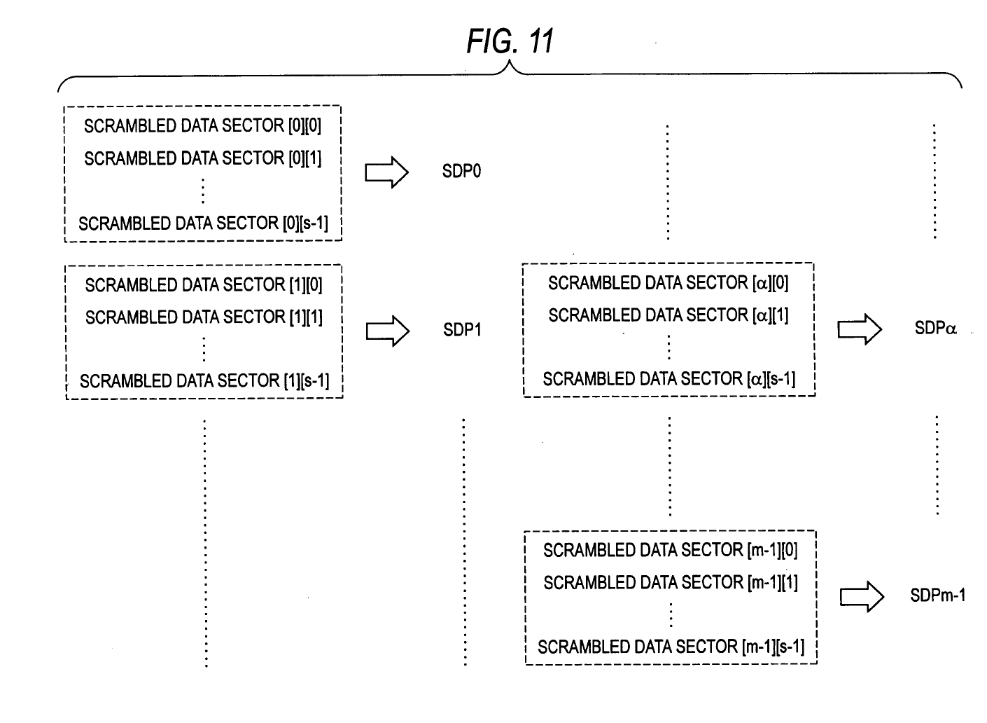

The page joining process A5 is conducted for the scrambled data sector. In this case, as shown in FIG. 11, s sectors are joined to one page to create a scrambled data page SDP.

More specifically, the scrambled data sectors, Scrambled Data Sector [0] [0], . . . , Scrambled Data Sector [0] [s−1] are joined to create a scrambled data page SDP0. Similarly, the scrambled data sectors are continuously joined to form scrambled data pages up to a scrambled data page SDP [m−1].

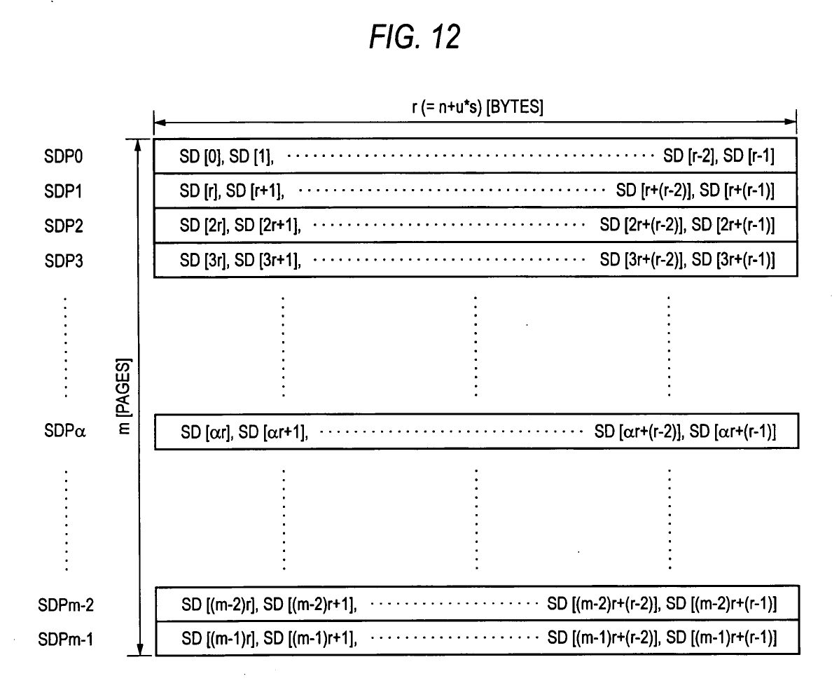

FIG. 12 shows the configuration of m pages of the individual scrambled data pages SDP0, SDP1, . . . , SDPm−1.

Each of the scrambled data pages is configured of r bytes, where r=n+u×s bytes.

As described in FIG. 2, the scrambled data pages SDP0, SDP1, . . . , SD Pm−1 are supplied from the scrambled data page generator 11 to the inner page encoder 12.

4. Inner Page Encoding Process

For the scrambled data pages SDP0, SDP1, . . . , SDPm−1 acquired in the data page creation process in the scrambled data page generator 11, the inner page encoding process is conducted in the inner page encoder 12.

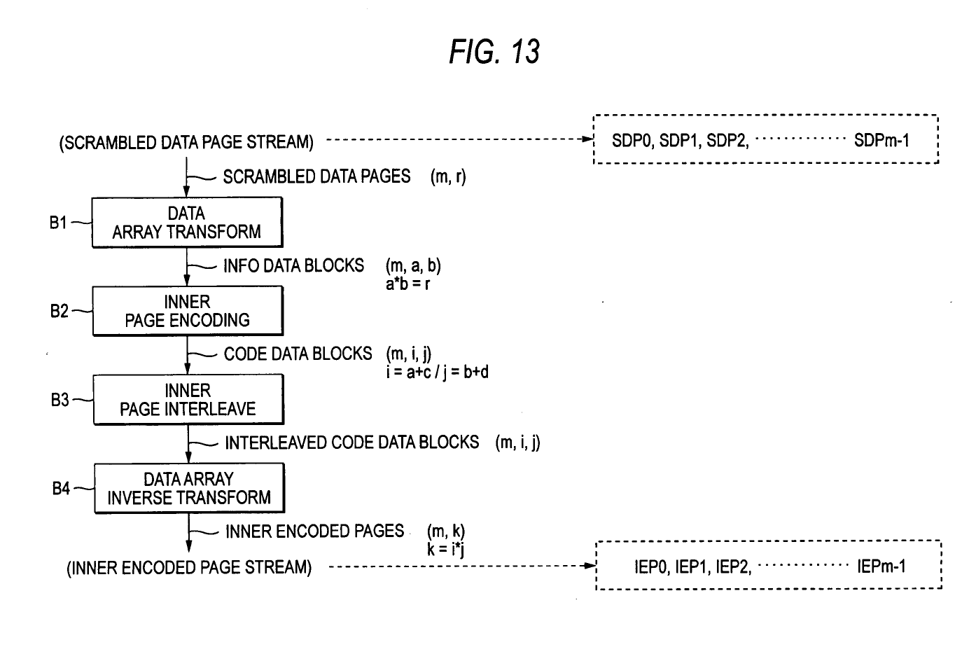

FIG. 13 shows the processes B1 to B4 done by the inner page encoder 12 shown in FIG. 3B above.

In the data array transform process B1, information data blocks are formed from the scrambled data page SDP.

In the inner page encoding process B2, code data blocks are formed from the information data block.

In the inner page interleave process B3, an interleaved code data block is formed from the code data block.

In the data array inverse transform process B4, an inner encoded page is formed from the interleaved code data blocks.

Each of the processes will be described sequentially.

The inputted scrambled data pages SDP0, SDP1, . . . , SDPm−1 are inputted to the inner page encoder 12, and the arrangement thereof is converted to create an information data block for inner page encoding in the data array transform process B1.

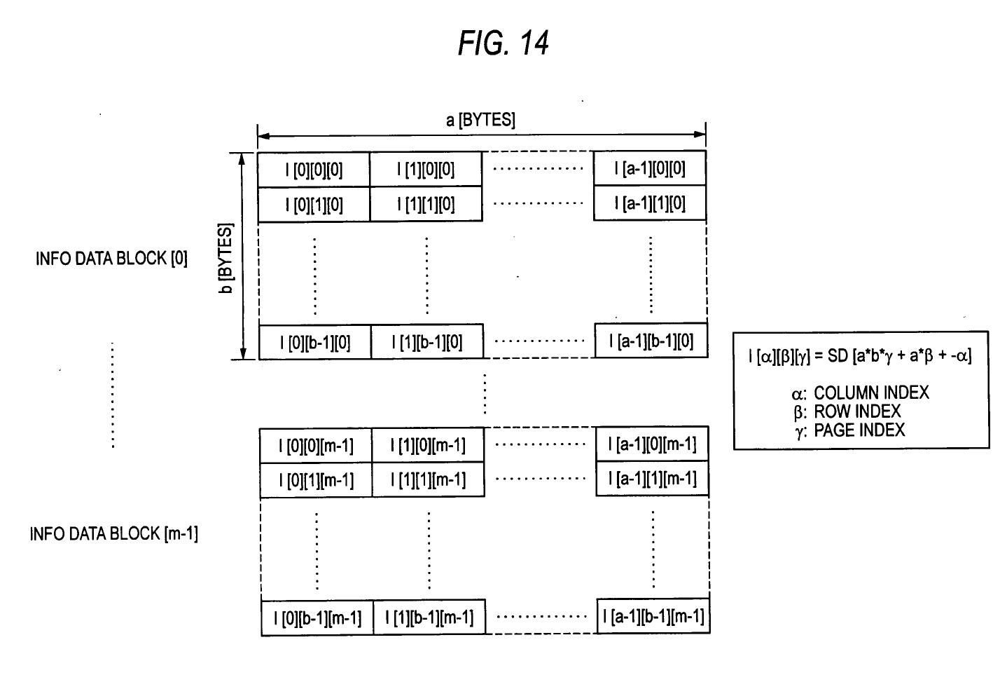

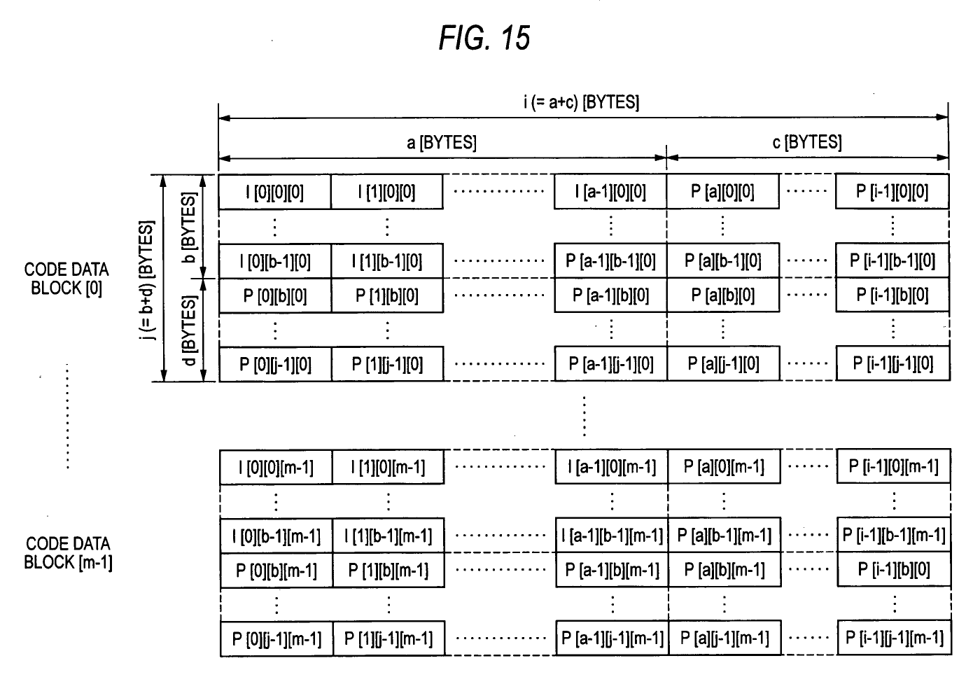

FIG. 14 shows an example in which the byte configuration of each of the scrambled data pages is arranged in a form of a bytes in row×b bytes in column for two-dimensional product encoding, where a×b=r. r bytes is the number of bytes configuring a single scrambled data page as shown in FIG. 12.

For example, FIG. 14 shows an information data block Info Data Block [0] in which data SD[0], . . . , SD[r−1] configuring a scrambled data page (Scrambled Data Page [0]=SDP0) shown in FIG. 12 are arranged in a form of a bytes in row×b bytes in column, representing data transformed in the array as I[0] [0] [0], . . . , I[a−1] [b−1] [0].

As described above, the arrangement of each of the scrambled data pages SDP0, SDP1, . . . , SDPm−1 is transformed to form information data blocks, Info Data Block [0], Info Data Block [1], . . . , Info Data Block [m−1].

In addition, the notations of I[α] [β] [γ] are as follows: α is a column index (column number) , β is a row index (row number) and γ is a page index (page number)

The correspondence between the scrambled data page data SD and I[α] [β] [γ] converted in array is I[α] [β] [γ]=SD[a·b·γ+a·β+−α].

Subsequently, in the inner page encoding process B2, the correction parity is added to the information data block (Info Data Block) to create a code data block. FIG. 15 shows an example in which c bytes of parities P are added in the row direction and d bytes of parities P are added in the column direction.

For example, to the information data block Info Data Block [0] shown in FIG. 14, c bytes of Parities P[a] [0] [0], . . . , are added in the row direction, and d bytes of Parities P[0] [b[0], . . . , are added in the column direction to crate i×j bytes of a code data block Code Data Block [0] as shown in FIG. 15, where i=a+c, j=b+d.

Similarly, parities P are also added to the other information data blocks. Therefore, m blocks of code data blocks, Code Data Block [0], . . . , Code Data Block [m−1] are formed.

For the created code data block Code Data Block [0], Code Data Block [m−1], the interleave process is conducted which is completed inside the page in the inner page interleave process B3.

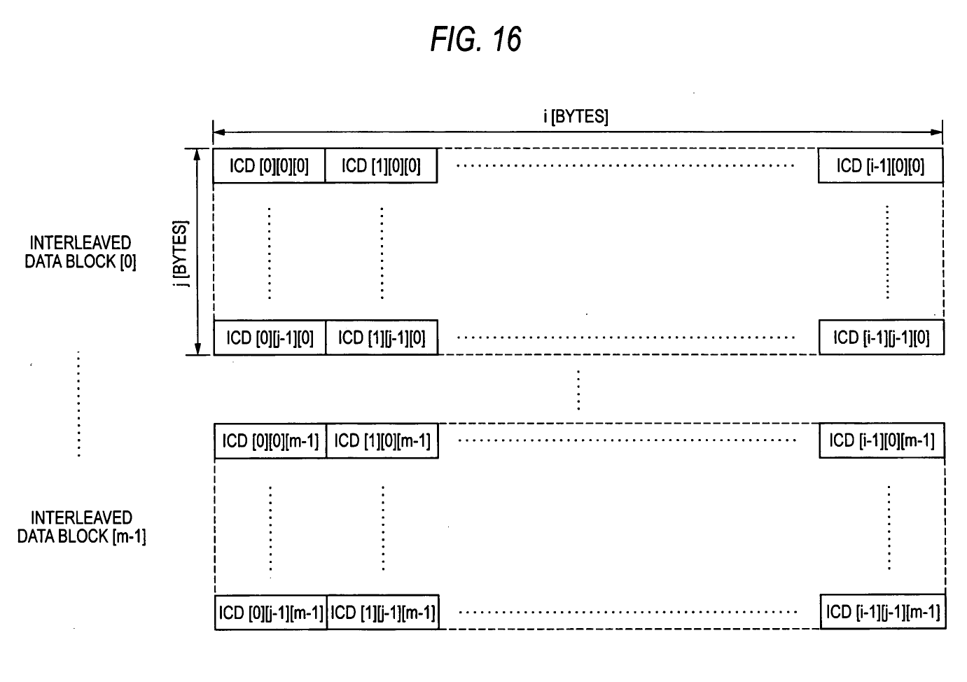

FIG. 16 shows interleaved code data blocks, Interleaved Code Data Block [0], . . . , Interleaved Code Data Block [m−1], in which the code data blocks, Code Data Block [0], . . . , Code Data Block [m−1] are inner page interleaved.

For example, data I[0] [0] [0], . . . , P[i−1] [j−1] [0] configuring the Code Data Block [0] shown in FIG. 15 are interleaved to be data ICD[0] [0] [0], . . . , ICD[i−1] [j−1] [0] shown in FIG. 16, and are i×j bytes of an interleaved code data block [0].

In the data array inverse transform process B4, m blocks of interleaved code data blocks created as shown in FIG. 16 are inverse transformed in the data array in units of original pages, and inner encoded pages IEP are created.

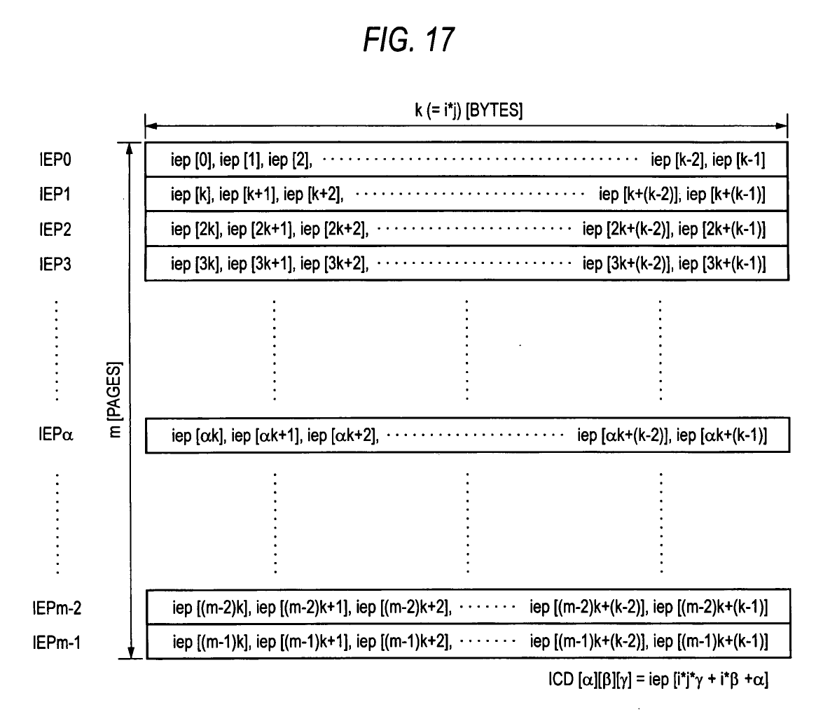

FIG. 17 shows inner encoded pages IEP0, . . . , IEPm−1. It is an example in which there are m pages of k bytes (k=I×j) of inner encoded pages.

For example, the arrangement of an interleaved code data block [0] shown in FIG. 16 is inverse transformed to be k bytes of an inner encoded page IEP0, data iep[0], . . . , iep[k−1], shown in FIG. 17. Similarly, the arrangements of interleaved code data blocks after that are inverse transformed to be k bytes of inner encoded pages IEP1, . . . , IEPm−1 as shown in FIG. 17.

As described in FIG. 2, the inner encoded pages IEP0, IEP1, . . . , IEPm−1 are outputted from the inner page encoder 12, and supplied to the outer page encoder 13.

5. Interpage Encoding Process

For the inner encoded pages IEP0, IEP1, . . . , IEPm−1 acquired in the inner page encoding process done by the inner page encoder 12, the interpage encoding process is conducted in the outer page encoder 13.

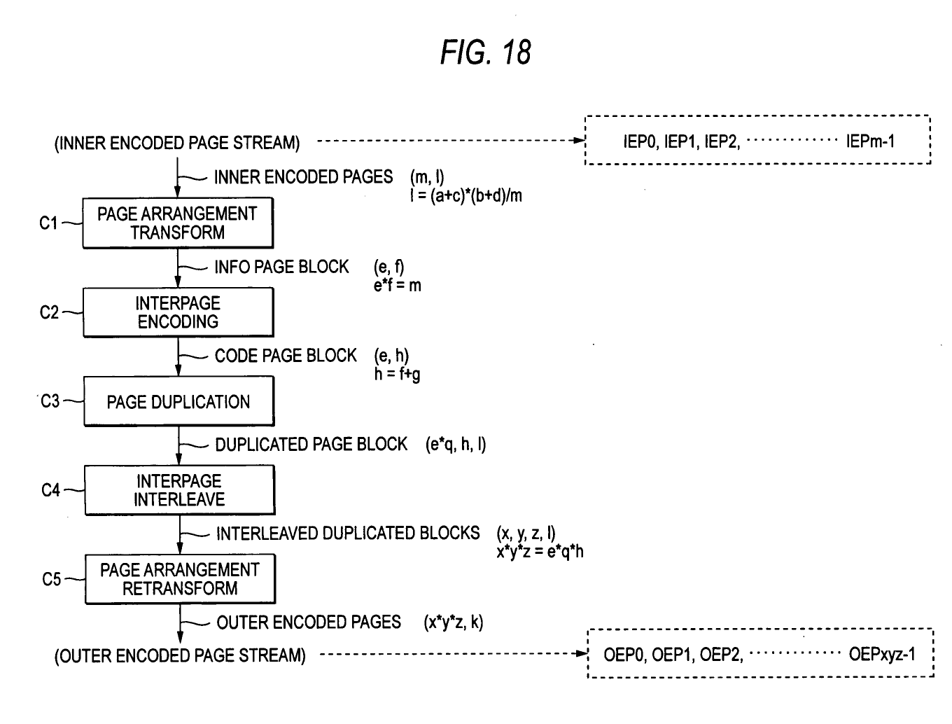

FIG. 18 shows the processes C1 to C5 done by the outer page encoder 13 shown in FIG. 3C above.

In the page arrangement transform process C1, information page blocks are created from the inner encoded pages IEP.

In the interpage encoding process C2, code page blocks are created from the information page blocks.

In the page duplication process C3, duplicated page blocks are created from the code page blocks.

In the interpage interleave process C4, interleaved duplicated blocks are created from the duplicated page blocks.

In the page arrangement retransform process C5, outer encoded pages are created from the interleaved duplicated blocks.

Each of the processes will be described sequentially.

The inner encoded pages IEP0, IEP1, . . . , IEPm−1 are inputted to the outer page encoder 13, and the arrangements thereof are transformed to create information page blocks for interpage encoding in the page arrangement transform process C1.

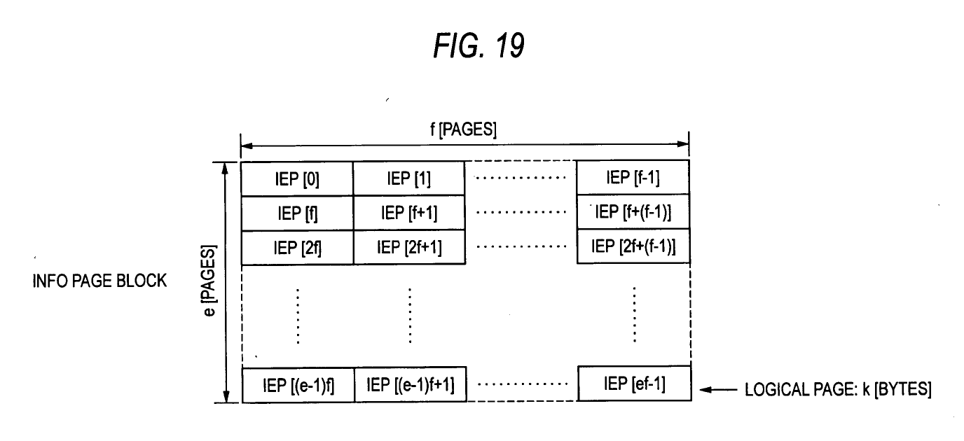

FIG. 19 shows an exemplary information page block in which the arrangements of the inner encoded pages IEP0, IEP1, . . . , IEPm−1 are transformed into a form in f pages in row×e pages in column. Each of the inner encoded pages transformed in the arrangement is represented by IEP[0] TEP[1], . . . , IEP[ef−1].

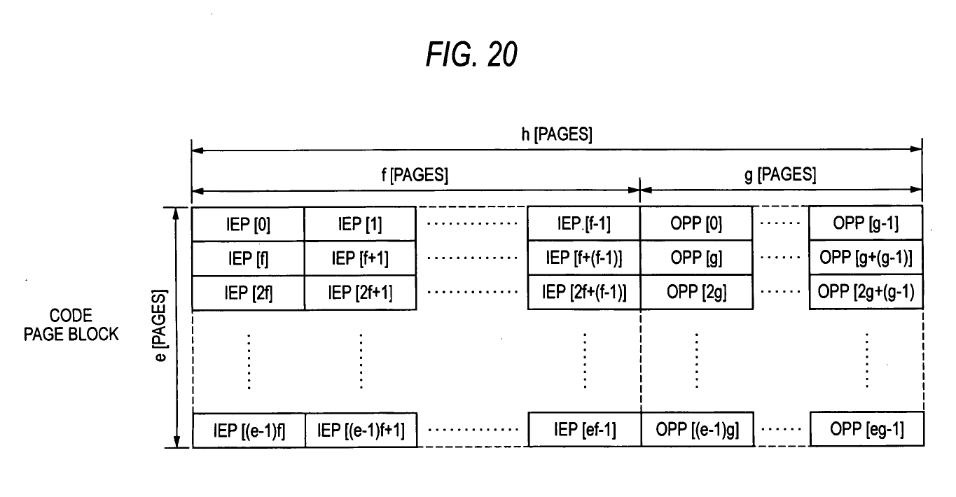

Subsequently, in the interpage encoding process C2, an interpage correction parity page is added to the information page block, and a code page block is created. FIG. 20 shows an exemplary code page block which is created by adding g pages of outer parity pages OPP[0], . . . , OPP[eg−1] are added in the row direction.

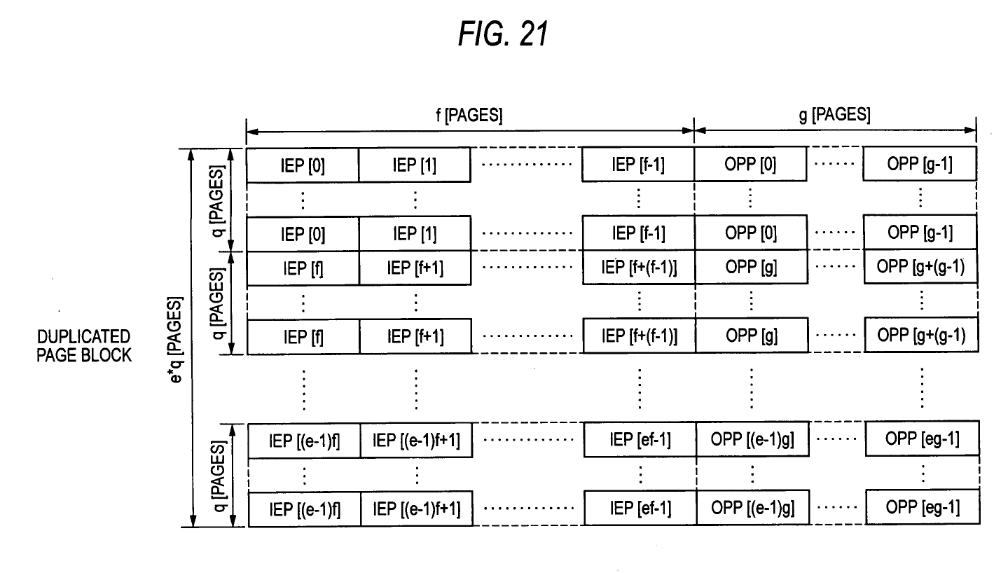

For the code page block, in the page duplication process C3, each page is duplicated into a multiple pages to create a duplicated page block. FIG. 21 shows an exemplary duplicated page block in which each of code pages in the code page blocks is duplicated by q blocks. Here, each of the code pages is inner encoded pages IEP[0], IEP[1], . . . , IEP[ef−1], and outer parity pages OPP[0], . . . , OPP[eg−1].

For duplication, duplication is conducted such a way that each of the code pages IEP[0], IEP[1], . . . , IEP[f−1], OPP[0], . . . , OPP[g−1] in the first row among e pages in column shown in FIG. 20 is formed to be q rows (q pages in column) as shown in FIG. 21.

Similarly, duplication is conducted such a way that each of the code pages IEP[f], IEP[f+1], . . . , IEP[f+(f−1)]) OPP[g], . . . , OPP[g+(g−1)] in the second row among e pages in column shown in FIG. 20 is formed to be q rows (q pages in column) as shown in FIG. 21.

Hereinafter, duplication is similarly conducted to create e×q pages in column of a duplicated page block shown in FIG. 21.

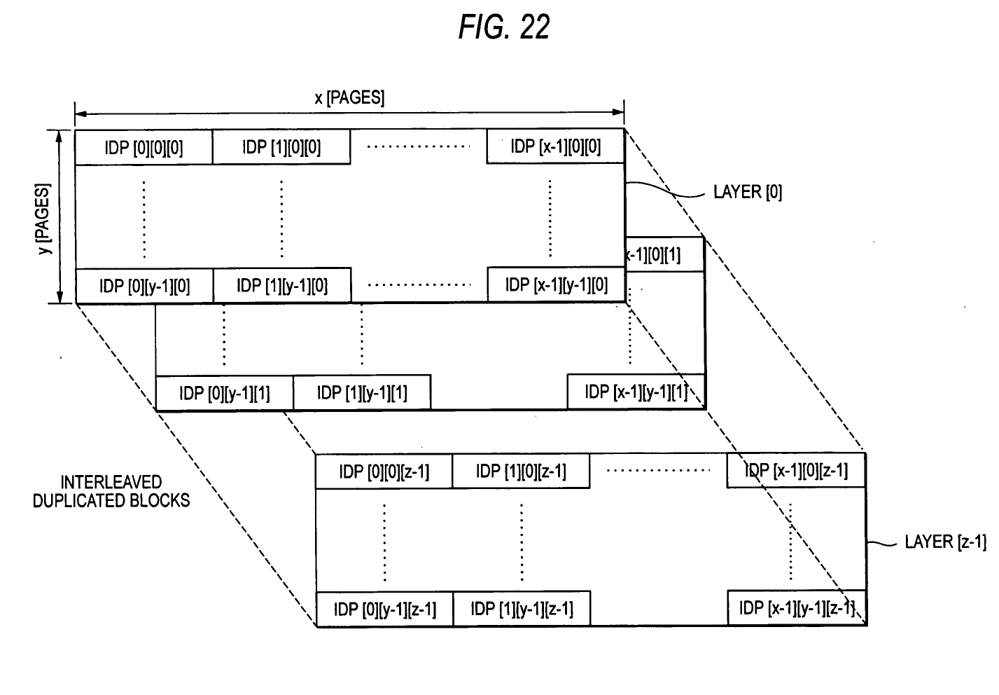

For the duplicated page block, the interleave process crossing over pages is conducted in the interpage interleave process C4, interleaved duplicated blocks are created as shown in FIG. 22.

FIG. 22 shows exemplary interleaved duplicated blocks which are interleaved and transformed in arrangement in a form of xpages in the row direction x y pages in the column direction x z pages in the angle multiplexing direction.

In FIG. 22, each page block in the angle multiplexing direction is represented by a rayer, and z pages of rayers are represented by Rayer[0], . . . , Rayer[z−1].

In the page block of each rayer, the individual interleaved pages are represented by IDP[x] [y] [z]. For example, individual pages in Rayer[0] is represented by IDP[0] [0] [0], . . . , IDP[x−1] [y −1] [z].

As described above, the page arrangements of the interleaved duplicated blocks are again transformed into units of pages in the page arrangement retransform process C5, and outer encoded pages OEP are created.

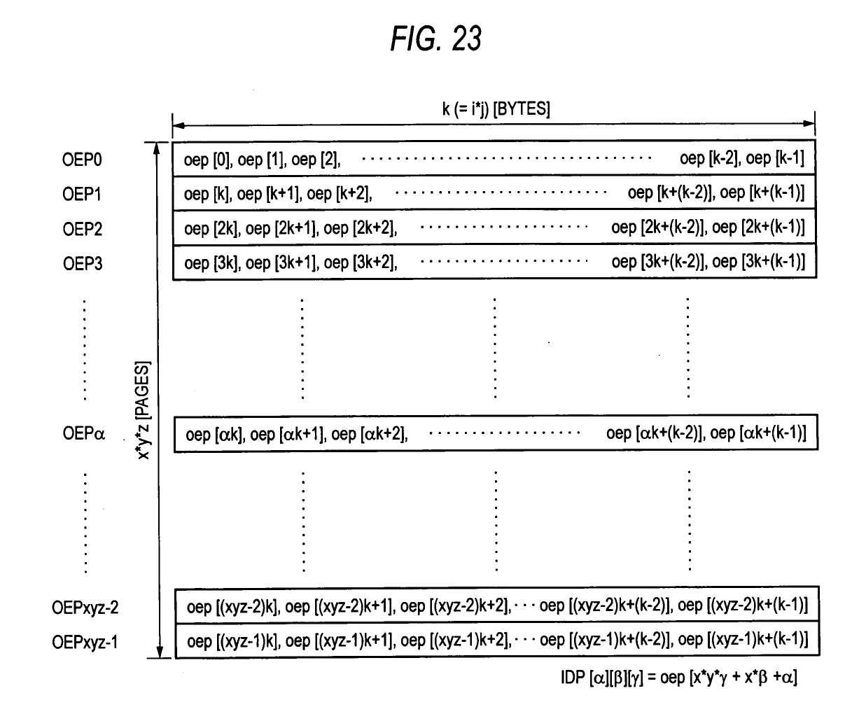

FIG. 23 shows outer encoded pages OEP0, . . . , OEPxyz−1. It is an example in which there are x·y·z pages of k bytes of an outer encoded page.

The page arrangements of the interleaved duplicated blocks shown in FIG. 22 are again transformed to create outer encoded pages as k bytes of an outer encoded page OEP0 formed of iep[0], . . . , iep[k−1], k bytes of an outer encoded page OEP1 formed of iep[k, . . . , iep[k+(k−1)], and so on as shown in FIG. 23.

The outer encoded pages OEP0, . . . , OEPxyz−1 are outputted from the outer page encoder 13 as described in FIG. 2, and are supplied to the hologram unit matrix generator 14.

6. Hologram Matrix Creation Process

The outer encoded pages OEP0, OEP1, . . . , OEPxyz−1 are supplied to the hologram unit matrix generator 14 to form a hologram unit matrix 20 on a hologram material that finally forms a hologram memory or a master medium thereof.

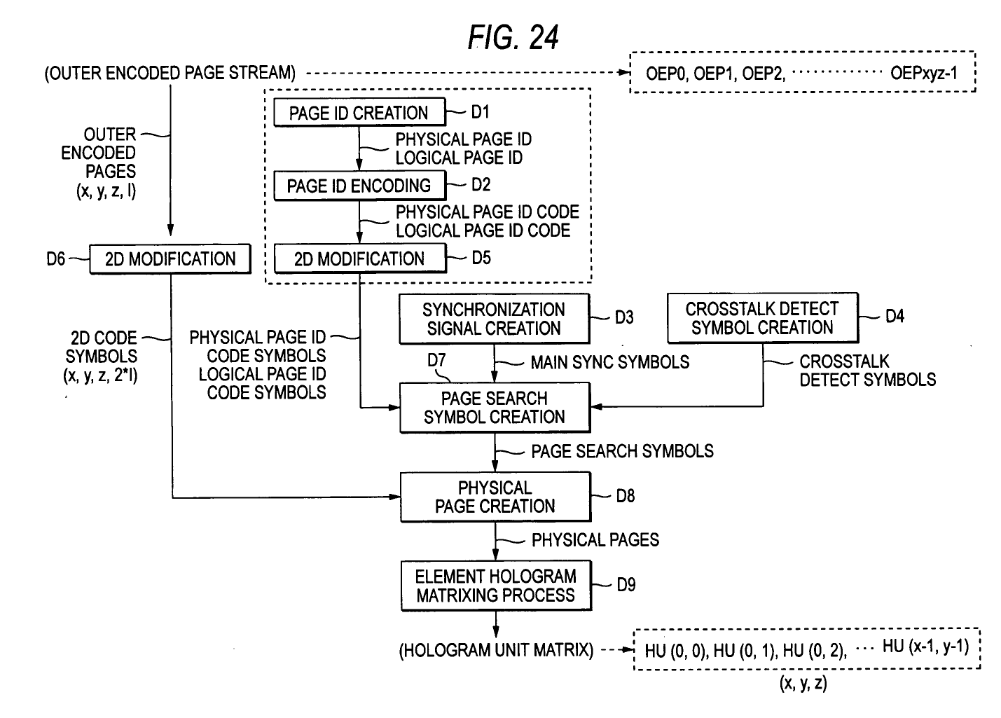

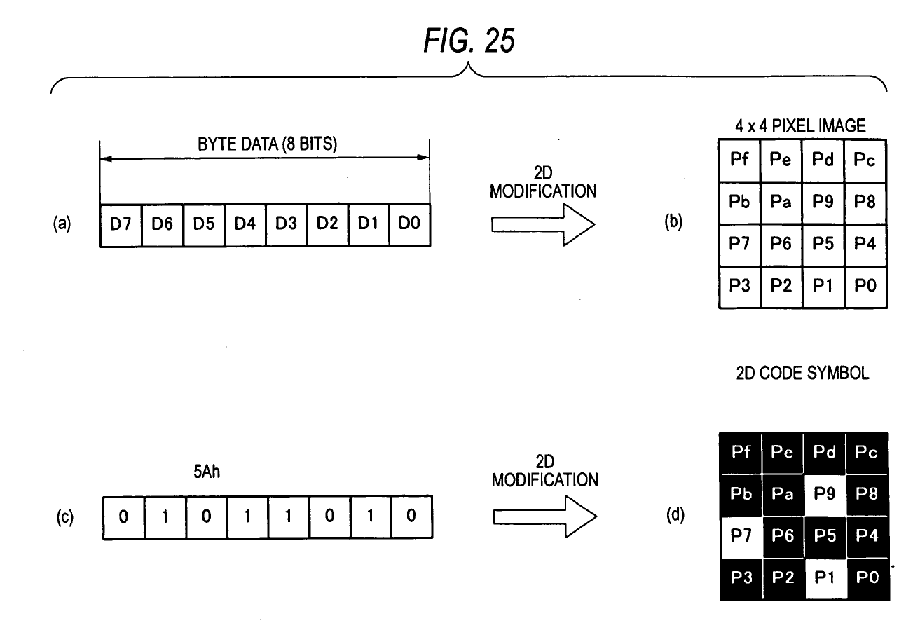

FIG. 24 shows the processes done by the hologram unit matrix generator 14, showing the processes in FIG. 3D more detailedly.

As shown in FIG. 24, the outer encoded page stream of the outer encoded pages OEP0, OEP1, . . . , OEPxyz−1 from the outer page encoder 13 is converted into 2D code symbols in the first two-dimensional modification process D6.

In addition, in the hologram unit matrix generator 14, a physical page ID and a logical page ID are created in the page ID creation process D1. The physical page ID and the logical page ID are coded in the page ID encoding process D2, and formed into a physical page ID code and a logical page ID code.

Moreover, the second two-dimensional modification process D5 is conduced for the physical page ID code and the logical page ID code, and are converted into physical page ID code symbols and logical page ID code symbols as two-dimensional patterns.

In addition, in the hologram unit matrix generator 14, in the synchronization signal creation process D3, main sync symbols are created which detect the slice position of the 2D symbol.

In addition, in the hologram unit matrix generator 14, crosstalk detect symbols are created in the crosstalk detect symbol creation process D4.

Then, the physical page ID code symbols, the logical page ID code symbols, the main sync symbols, and the crosstalk detect symbols are synthesized in the page search symbol creation process D7, and page search symbols are created as two-dimensional patterns.

The page search symbols are synthesized with the 2D code symbols in the physical page creation process D8 to create physical pages. Then, each of the physical pages is recorded on the hologram material as element holograms in the element hologram matrixing process D9, and the hologram unit matrix 20 is formed on which element holograms HU (0, 0), . . . , HU (x−1, y−1) are recorded as shown in FIG. 2. More specifically, as described in FIG. 1A, the element holograms are recorded on the hologram material with the interference fringes of the object beams L2 and the record reference beams L3 while each of the physical pages is sequentially displayed on the liquid crystal panel 1. At this time, each of the physical pages is recorded while the application angle of the record reference beams L3 is varied, whereby the element holograms are kept formed in the angle multiplexing scheme.

Each of the processes in the hologram unit matrix generator 14 will be described.

In the two-dimensional modification process D6, the outer encoded pages OEP0, OEP1, . . . , OEPxyz−1from the outer page encoder 13 are converted into 2D code symbols.

FIG. 25 shows the two-dimensional modification process.

The byte data as eight bits of binary codes D0 to D7 shown in (a) in FIG. 25 is converted into 2D code symbols as 4×4 pixels of a two-dimensional pattern shown in (b) in FIG. 25. For each of the pixels P0, P1, . . . , Pf in the two-dimensional pattern, either of the white level or the black level is selected depending on the value of byte data, that is, the eight bit value of D0 to D7.

For an example, a value “01011010” is shown in (c) in FIG. 25, that is, the byte data of “5Ah” (h denotes the hexadecimal notation) is shown. The value is converted into 2D code symbols shown in (d) in FIG. 25. In this example, three pixels, pixels P1, P7 and P9 are the white level and the remaining 13 pixels are the black level.

Here, in order to represent eight bits of byte data, the 2D code symbols below are necessary.
2⁸=256 [symbols].
Here, the number of types of three combinations among 13 pixels is determined, where “C” denotes combination.
13C3=286 [symbols]
256 different combinations can be represented with 13 pixels or greater for the number of pixels of 2D code symbols.

Consequently, three pixels as 4×4−13=3 can be allocated for the purposes other than the representation of byte data.

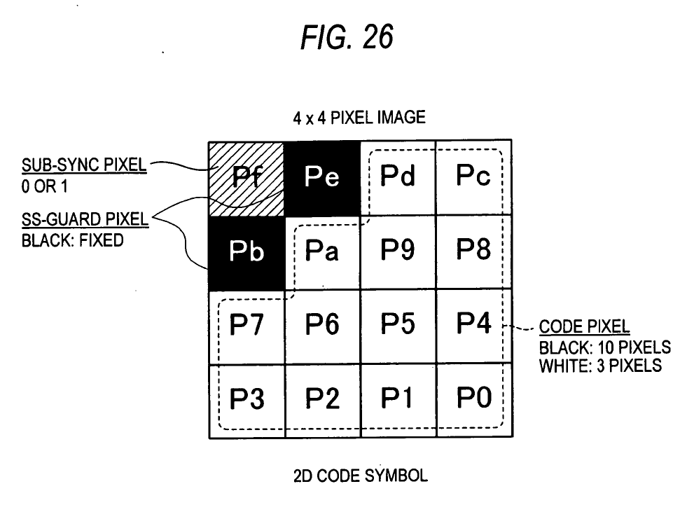

Then, as shown in FIG. 26, among 4×4 pixels, a pixel Pf is allocated as a sub-sync pixel to the pixel for a sub-synchronization pattern. To the pixels Pf, either of the white level or the black level is assigned when a group sub-sync (Group-SS) is created.

In addition, pixels Pb and Pe are assigned as sub-sync guard pixels (SS-Guard Pixel) which guard a sub-sync pixel. The pixels Pb and Pe are set to the black level all the time.

Then, pixels P0, . . . , Pa, Pc, Pd of the remaining 13 pixels are assigned as code pixels. Three pixels among 13 pixels are set to the white level, and 10 pixels are set to the black level in accordance with byte data that is desired to be modified.

Here, 13C3−2⁸=286−256=30 [symbols], and then 30 non-code symbols can be defined.

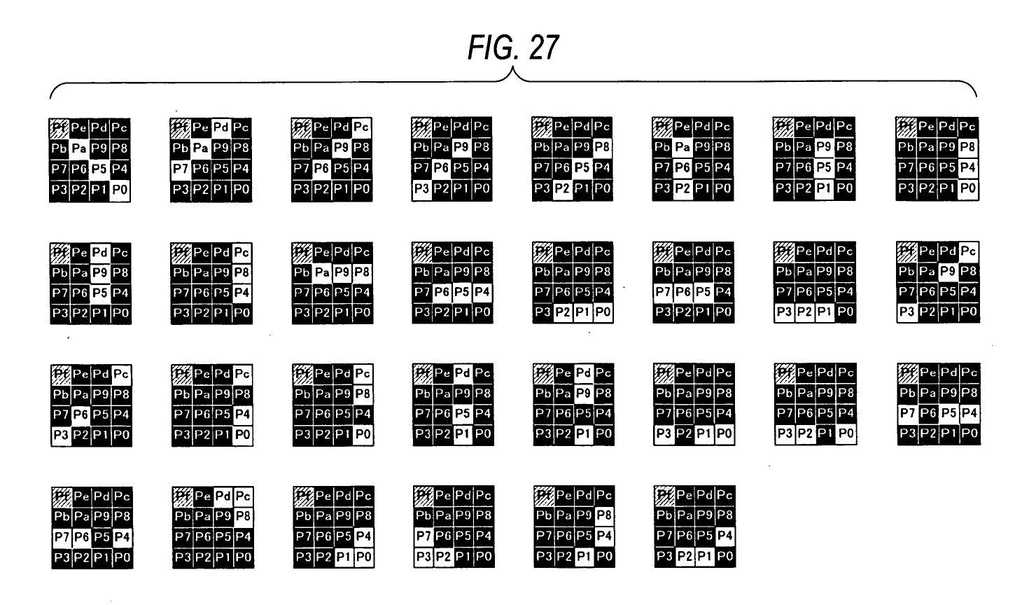

FIG. 27 shows exemplary 30 2D symbols to be excluded for run length limitation.

256 two-dimensional patterns except 30 symbols are allocated to byte data values “00h” to “FFh”.

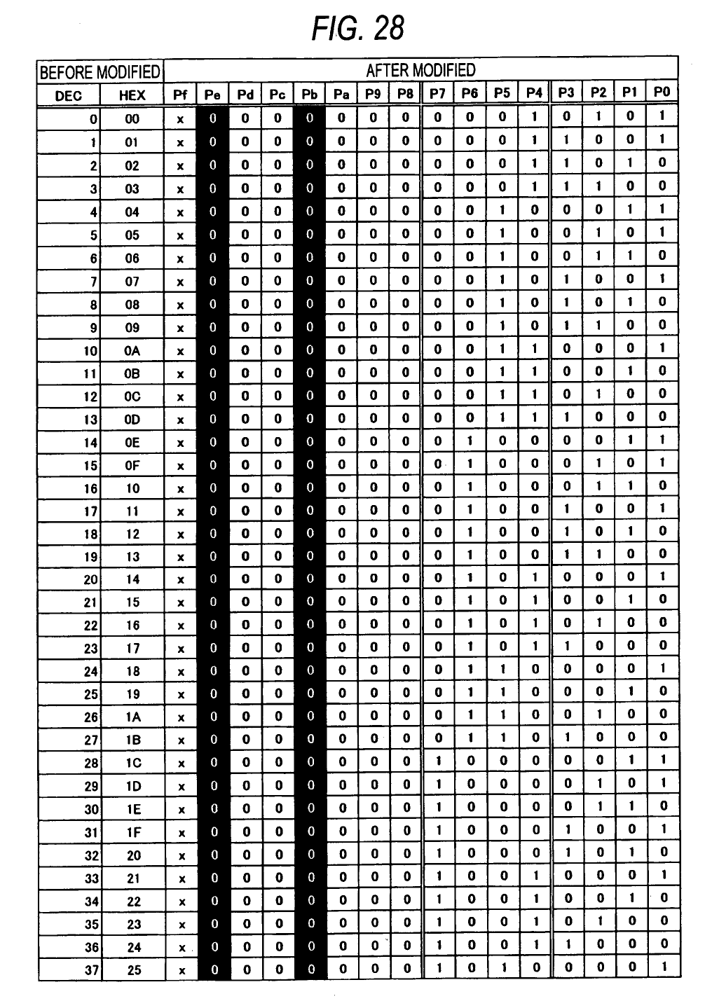

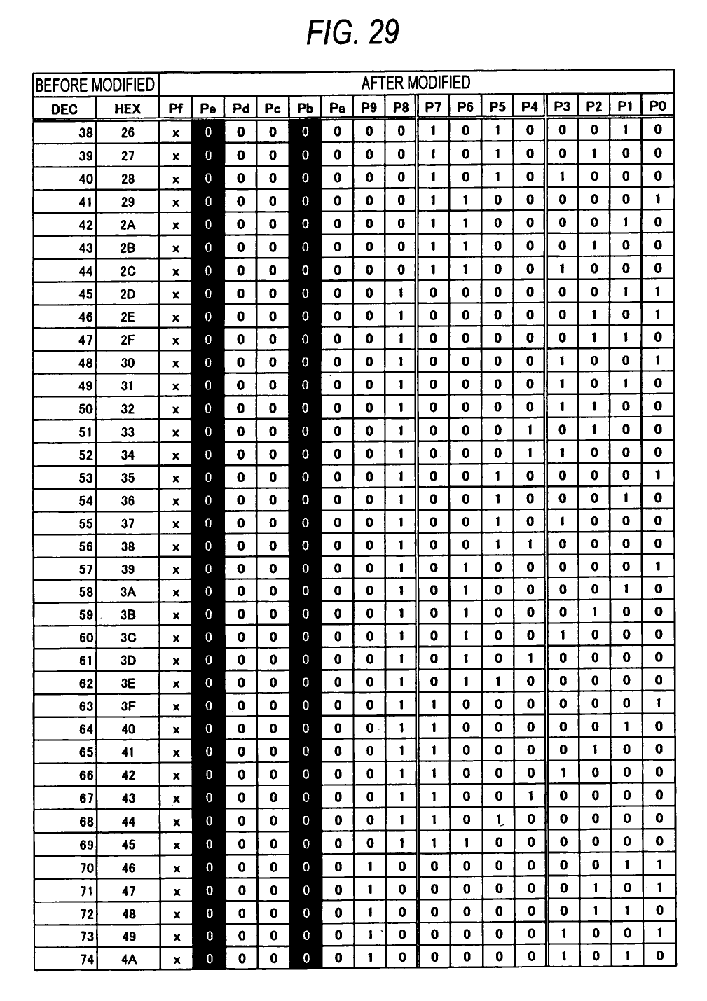

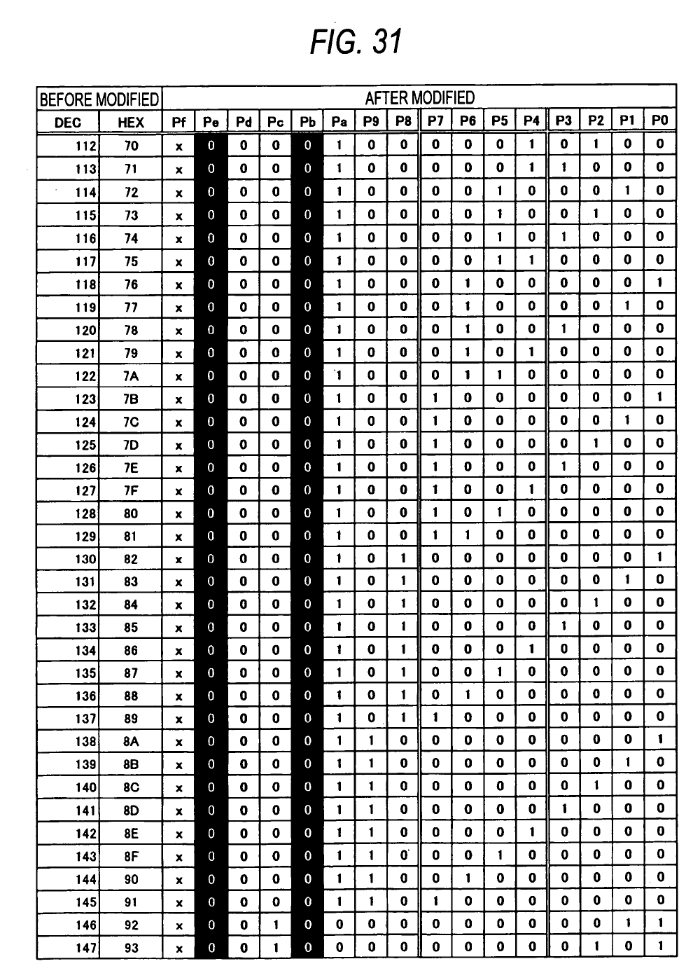

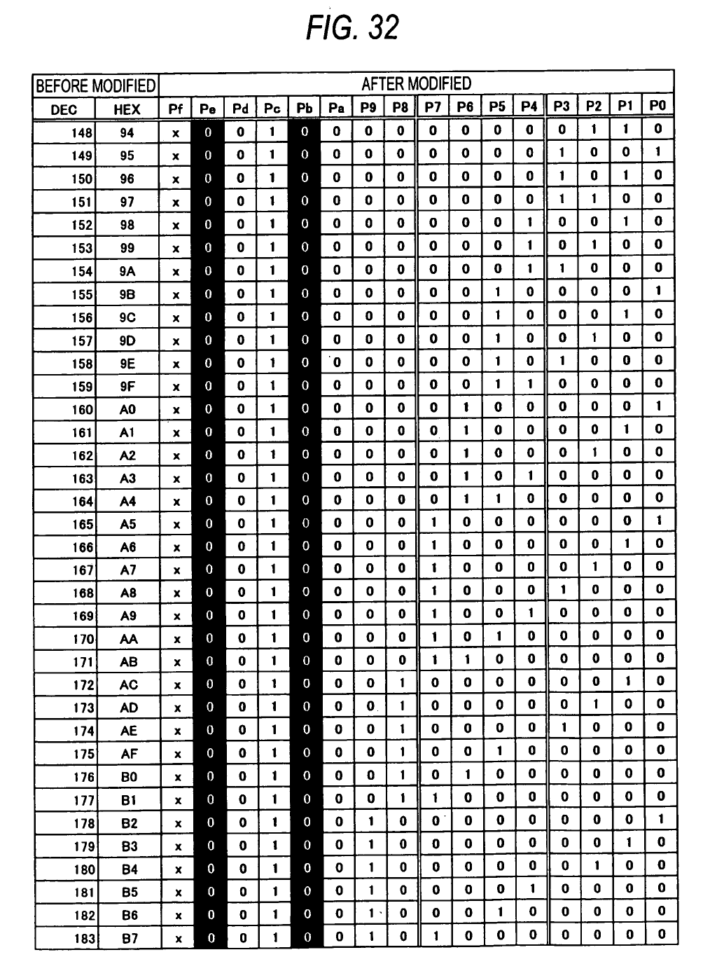

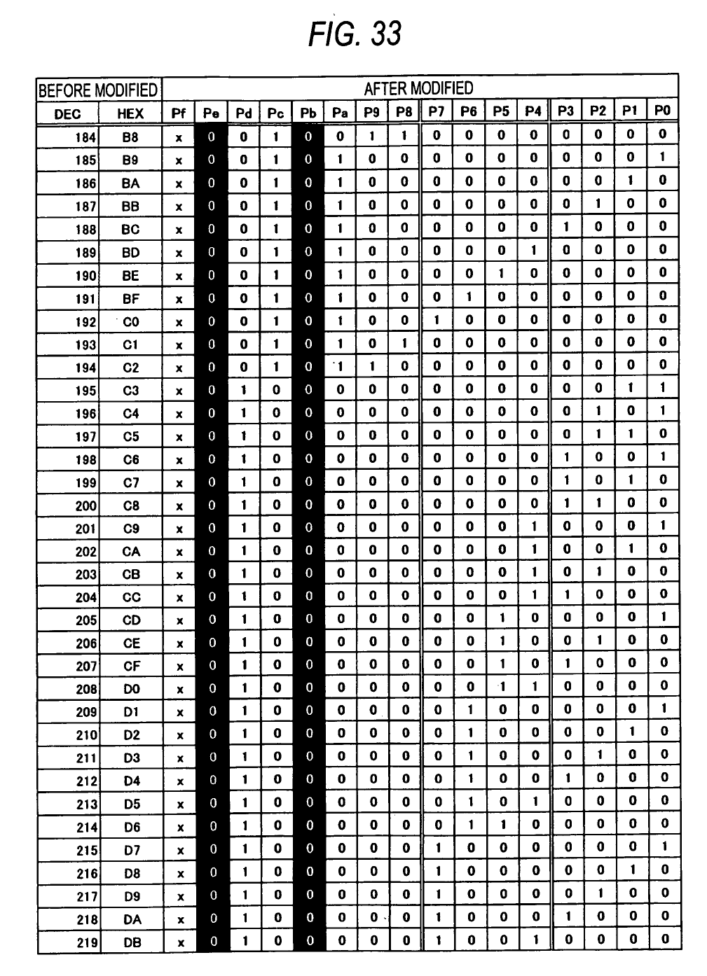

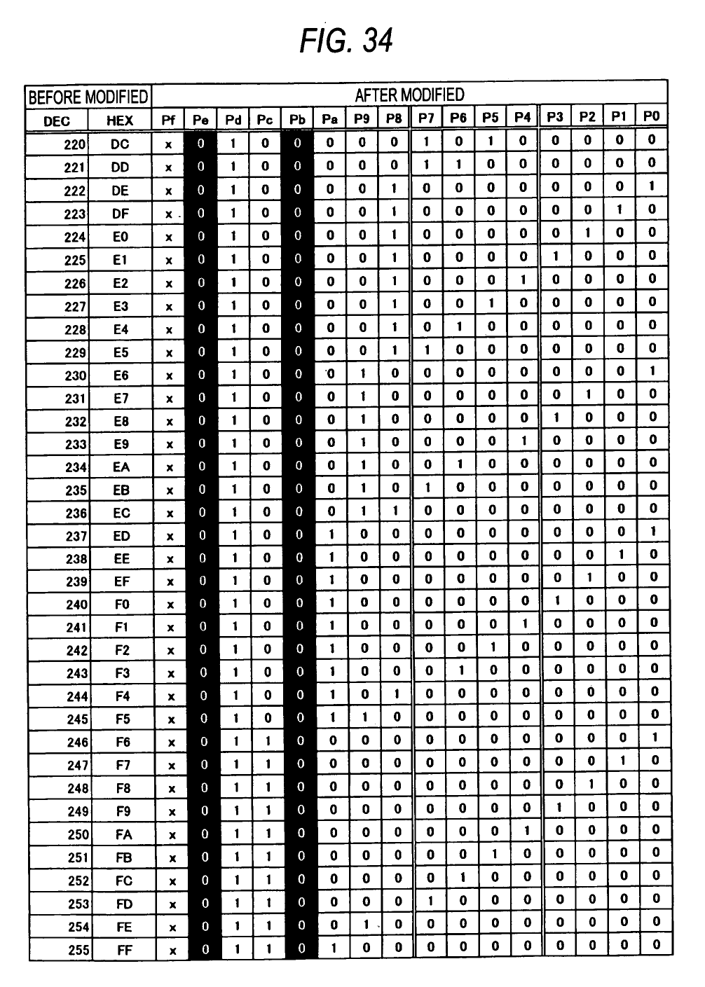

FIGS. 28, 29, 30, 31, 32, 33, and 34 show two-dimensional patterns representing the byte data values “00h” to “FFh”. In other words, they are modification tables from byte data to 2D code symbols. In addition, in these drawings, the pixel value “0” represents the black level, and “1” represents the white level.

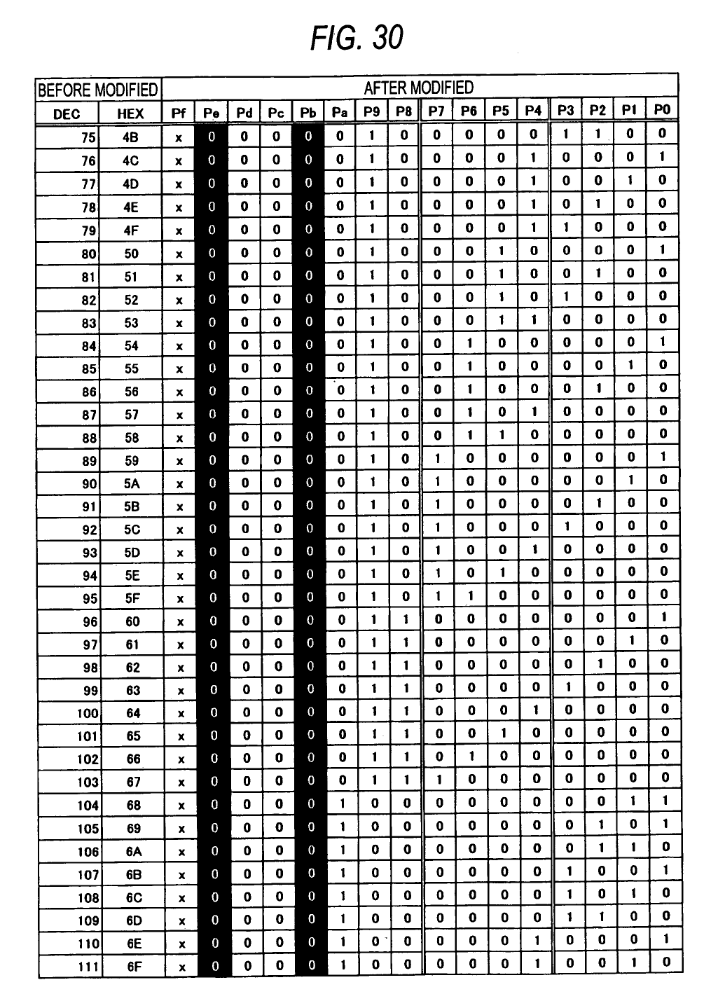

For example, as shown in FIG. 30, since the byte data value “5Ah” is assigned with the pattern that P1, P7 and P9 are the white level, it has 2D code symbols shown in (d) in FIG. 25 above.

In other words, as shown in FIG. 27, 30 patterns are excluded in which the white levels continue in column, row or diagonally. Then, among the remaining 256 patterns, 2D code symbols are created as the patterns selected from the modification tables shown in FIGS. 28 to 34 above depending on the value of one byte of binary data.

Although one byte of data is converted into 4×4 pixels of a 2D code symbol as described above, a group R (Group-R: group rotated) is created from four bytes, that is, four of 4×4 pixels of 2D code symbols.

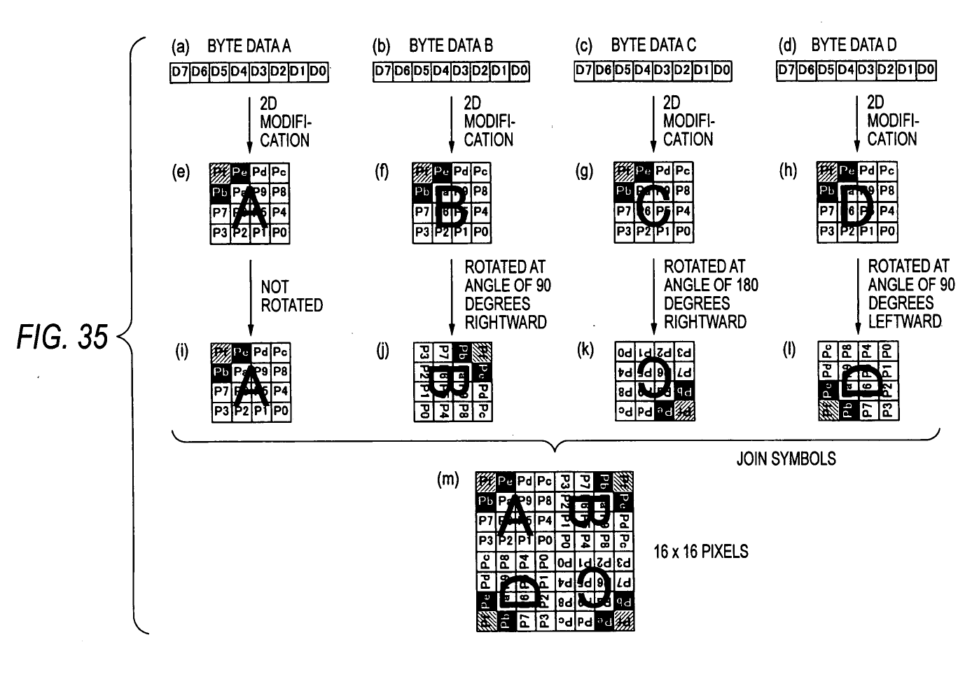

FIG. 35 shows a creation process for the group R. (a), (b), (c) and (d) in FIG. 35 shows four bytes as byte data A, byte data B, byte data C, and byte data D.

Each of the byte data is converted into 4×4 pixels of a two-dimensional pattern in accordance with the modification table. Two-dimensional patterns created in accordance with the values of the byte data A, B, C and D are shown in (e), (f), (g) and (h) in FIGS. 35.

To the four two-dimensional patterns, the rotating manipulation is applied as follows.

The two-dimensional pattern of byte data A: not rotated as shown in (i) in FIG. 35.

The two-dimensional pattern byte data B: rotated at an angle of 90 degrees rightward as shown in (j) in FIG. 35.

The two-dimensional pattern byte data C: rotated at an angle of 180 degrees as shown in (k) in FIG. 35.

The two-dimensional pattern byte data D: rotated at an angle of 90 degrees leftward as shown in (1) in FIG. 35.

Then, four symbols shown in (i), (j), (k) and (1) in FIG. 35 are joined to create 8×8 pixels of a group R shown in (m) in FIG. 35.

The group R is formed from four bytes of data as described above. Four patterns of the groups Rare synthesized to create a group sub-sync (Group-SS: Group Sub-Sync).

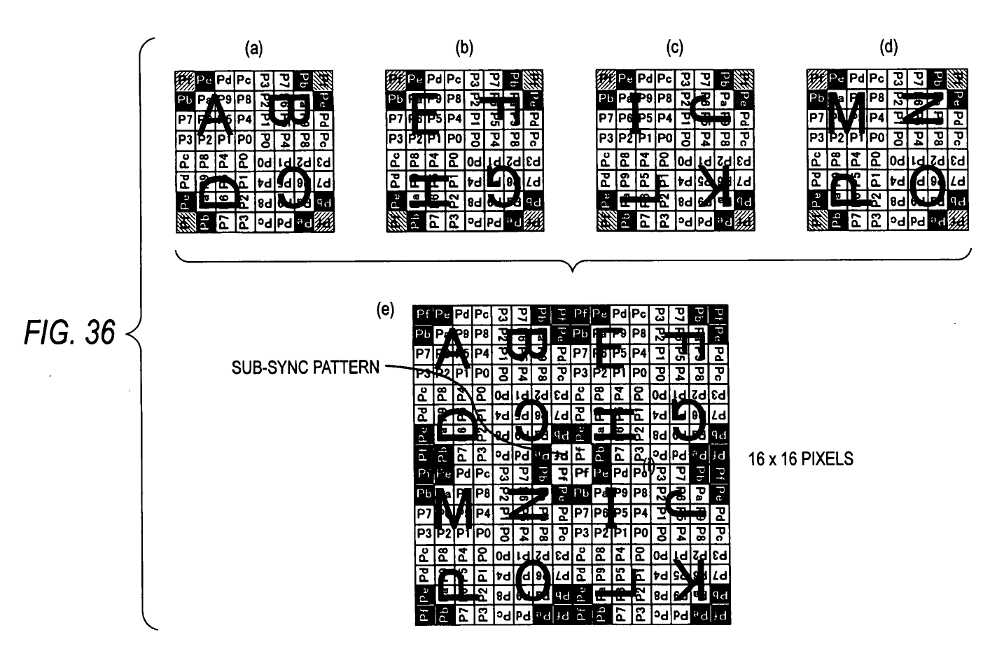

FIG. 36 shows a creation method of the group sub-sync.

As (a), (b), (c) and (d) in FIG. 36, four groups R are shown. More specifically, (a) in FIG. 36 is a group R created from byte data A, B, C and D, (b) in FIG. 36 is a group R created from byte data E, F, G and H, (c) in FIG. 36 is a group R created from byte data I, J, K and L, and (d) in FIG. 36 is a group R created from byte data M, N, 0 and P.

These four groups R are joined to create 16×16 pixels of a group sub-sync as shown in (e) in FIG. 36. At this time, the white level is assigned to the pixels Pf in four of 4×4 pixels of two-dimensional patterns of byte data C, H, I and N. Thus, as shown in the drawing, 2×2 pixels of four pixels Pf gathered at the center of the group sub-sync form four pixels of a white area, which is a sub-sync pattern.

In addition, to the pixels Pf of other byte data A, B, D, E, F, G, J, K, L, M, 0 and P, the black level is assigned to suppress the frequency of white pixels on the group sub-sync.

The group sub-syncs are formed in the two-dimensional modification process D6, and are supplied to the physical page creation process D8 shown in FIG. 24.

More specifically, in the two-dimensional modification process D6, the pixel Pf at a specific corner is established as a sub-sync pixel in 4×4 pixels of a 2D code symbol, and then 2D code symbol is created.

Subsequently, four 2D code symbols are formed in one set, a necessary rotation process is conducted for each of four 2D code symbols, and then they are synthesized, whereby a group rotated (group R) is created in which each of the sub-sync pixels Pf is positioned at four corners.

Moreover, four groups rotated (groups R) are arranged in a form of two groups in row and two groups in column, and then synthesized. The group sub-sync is created such a way that four sub-sync pixels Pf to be the white level gathered in 2×2 pixels at the center after synthesized to be a sub-sync pattern.

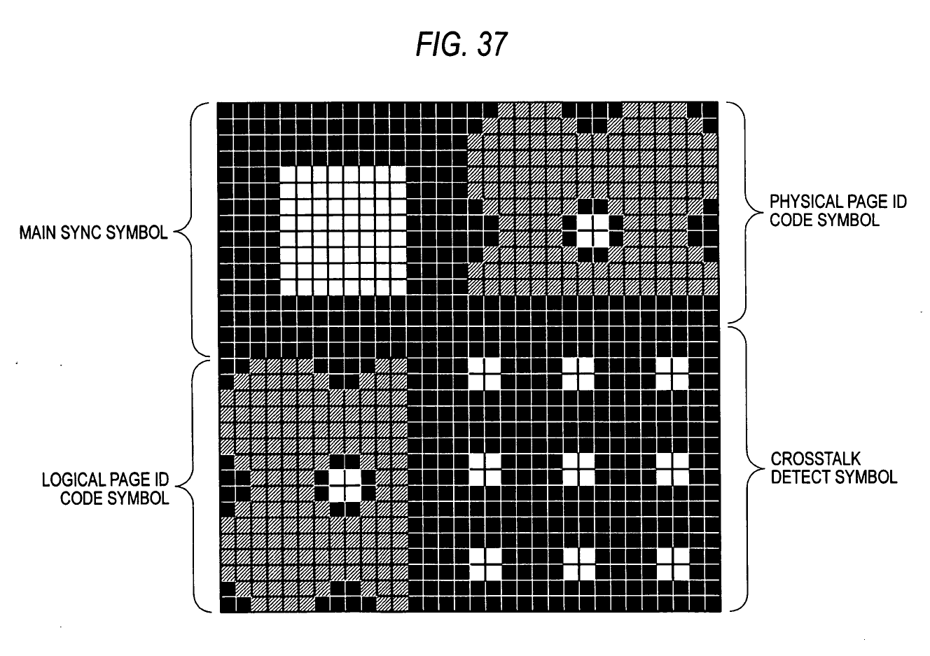

On the other hand, a page search symbol is created in the page search symbol creation process D7 shown in FIG. 24. As shown in FIG. 37, the page search symbol is a symbol that the physical page ID code symbol, the logical page ID code symbol, the main sync symbol, and the crosstalk detect symbol are synthesized. The page search symbol are formed of 32×32 pixels, that is, the number of pixels of four groups sub-sync.

Each symbol in the page search symbol will be described later. In the physical page creation process D8, the page search symbol is synthesized with the group sub-sync to form a group main-sync (Group-MS) , and a set of the groups main-sync is a physical page.

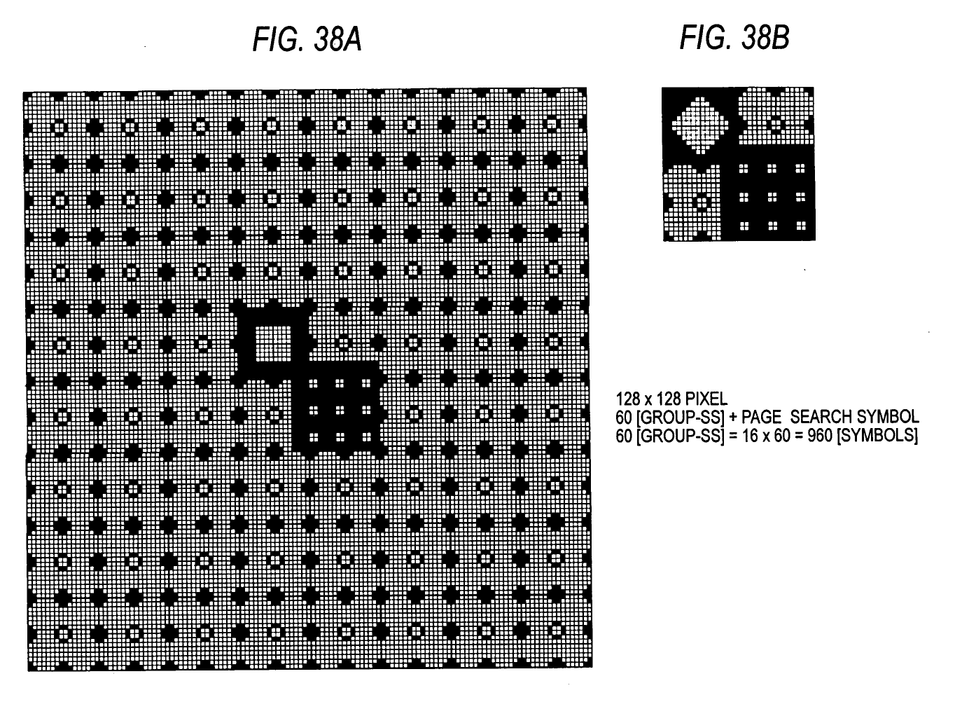

A group main-sync is shown in (a) in FIG. 38. The group main-sync is formed in which eight groups sub-sync are arranged in the row direction and eight groups are arranged in the column direction.

However, in this case, 64 groups sub-sync can be arranged. 2×2 groups of groups sub-sync (32×32 pixels) at a given position are blank to insert a page search symbol. FIG. 38 shows an example in which a page search symbol as shown in FIG. 37 is arranged at the center pixels (32×32 pixels) of four groups sub-sync.

More specifically, a page search symbol having a main sync symbol is arranged in the group sub-sync arrangement. The page search symbol is configured of pixels that are an integral multiple of 16×16 pixels of a group sub-sync.

Then, as described above, the group main-sync thus configured is formed of 128×128 pixels, including 60 groups sub-sync and a single page search symbol.

As described above, a single group sub-sync has 16×16 pixels, and includes 16 bytes of items of one byte data represented by 16 pixels. Therefore, the group main-sync includes 16×60=960 bytes (960 symbols) as data.

In addition, in the group main-sync, the positions of center of gravity of the main sync symbol and the sub-sync pattern (=four pixels at the white level at the center of the group sub-sync) maintain regularity both in the column direction and in the row direction.

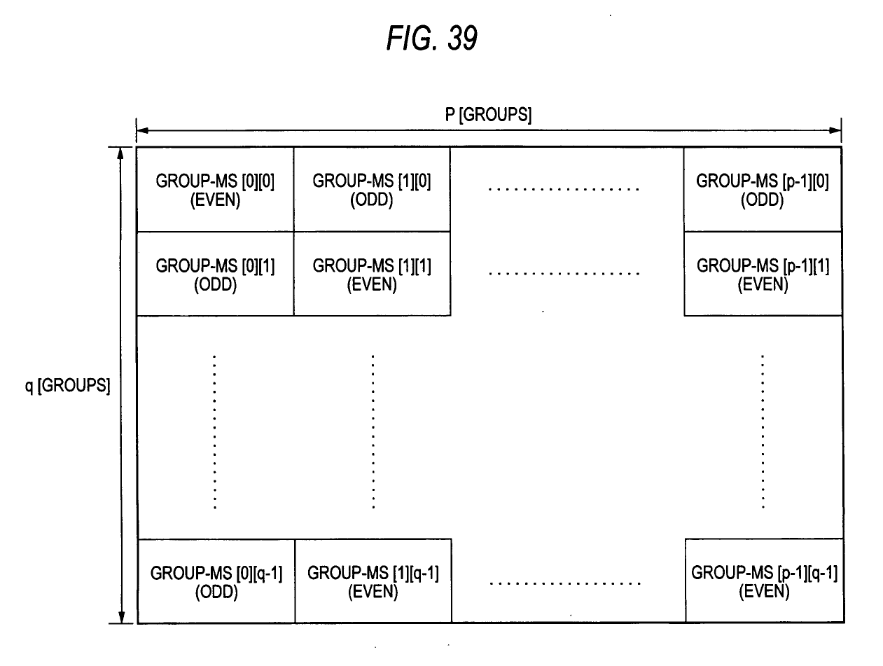

The group main-sync like this is further arranged in the two-dimensional plane to be a physical page. FIG. 39 shows an exemplary configuration of the physical page.

Here, an example is shown in which the groups main-sync Group-MS[0] [0], . . . , Group-MS[p−1] [q−1] are arranged to form a physical page in such a way that p groups are arranged in the row direction and q groups are arranged in the column direction.

In the physical page creation process D8 shown in FIG. 24, the physical page like this is formed, and supplied to the element hologram matrixing process D9. In other words, the physical page is displayed on the liquid crystal panel 1 as the two-dimensional page data shown in FIG. 1B.

In addition, in the physical page shown in FIG. 39, the even numbered groups main-sync are shown as “EVEN” and the odd numbered groups main-sync are shown as “ODD”. Then, both in the column direction and in the row direction, the even numbered group main-sync and the odd numbered group main-sync are alternately arranged.

In the odd numbered group main-sync and the even numbered group main-sync, the main sync symbols in the page search symbols are varied. For example, since the page search symbol shown in FIG. 37 is inserted into the even numbered group main-sync, it is as shown in (a) in FIG. 38. On the other hand, the page search symbol shown in (b) in FIG. 38 is inserted into the odd numbered group main-sync. As revealed from the comparison of (a) with (b) in FIG. 38, the patterns of the main sync symbols are varied.

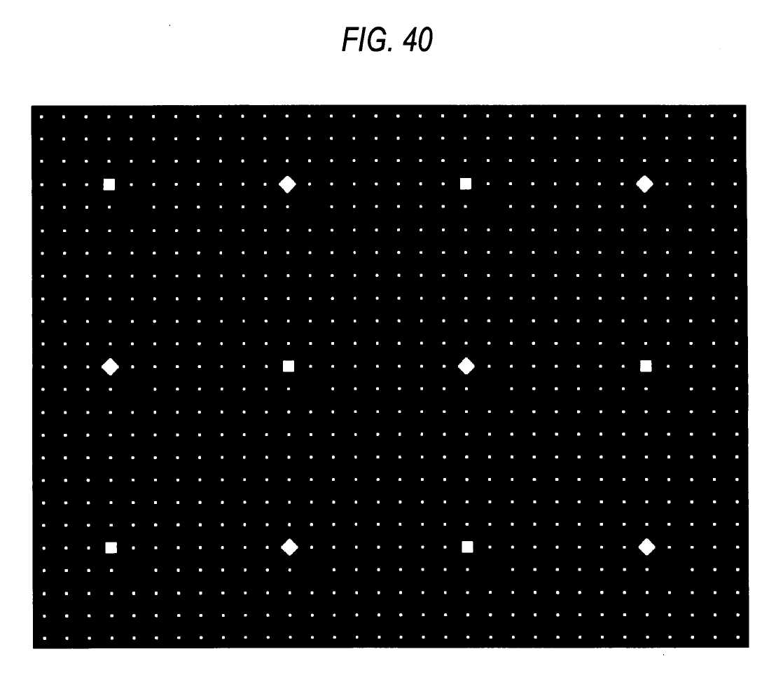

Here, examples of the physical pages are shown in FIGS. 40, 41, 42, 43 and 44. Here, an exemplary physical page is shown in which groups main synch are arranged in such a way that four groups are arranged in the row direction and three groups are arranged in the column direction where p=4 and q=3. Since a single group main-sync has 128×128 pixels, this physical page is configured of 512×384 pixels.

FIG. 40 shows an exemplary preamble page.

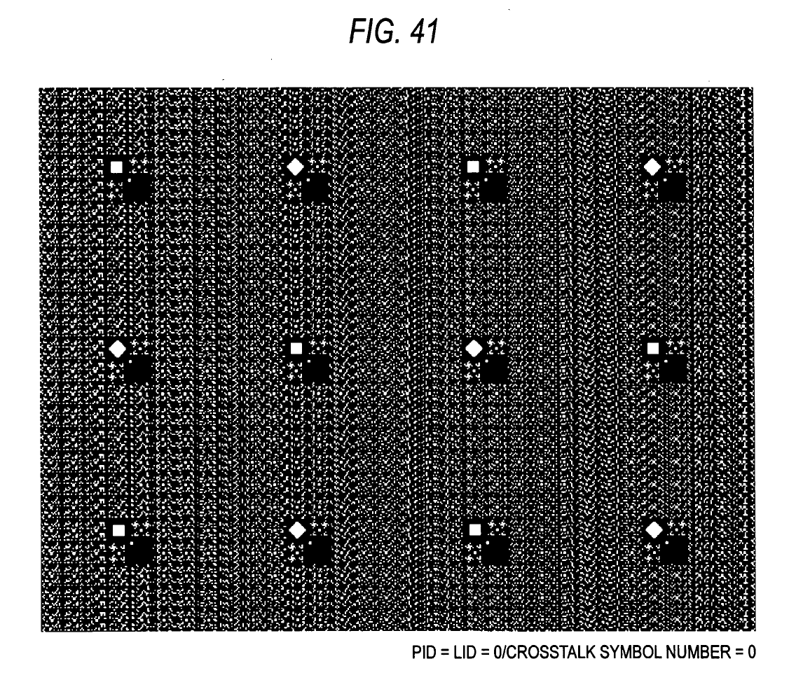

FIG. 41 shows exemplary increment data modification.

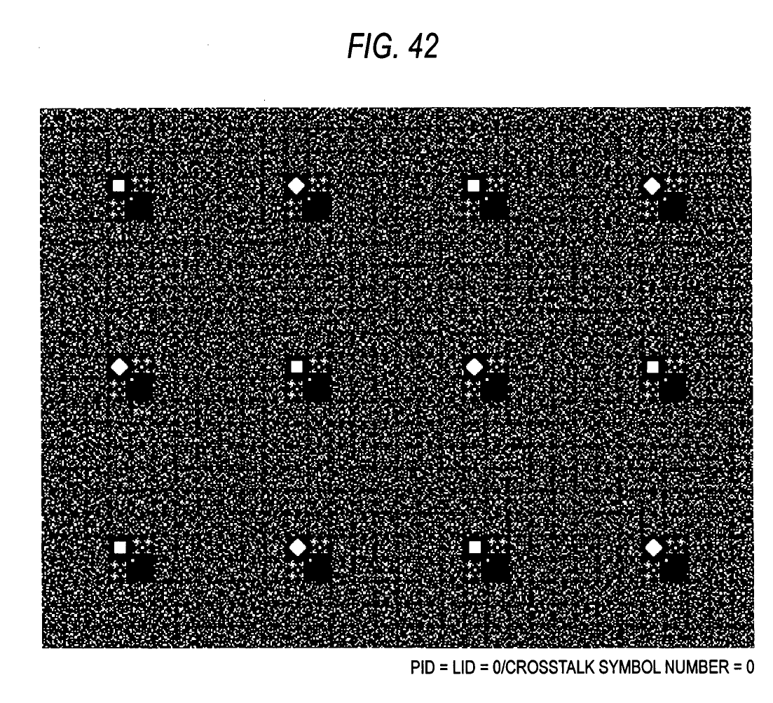

FIG. 42 shows exemplary random data modification.

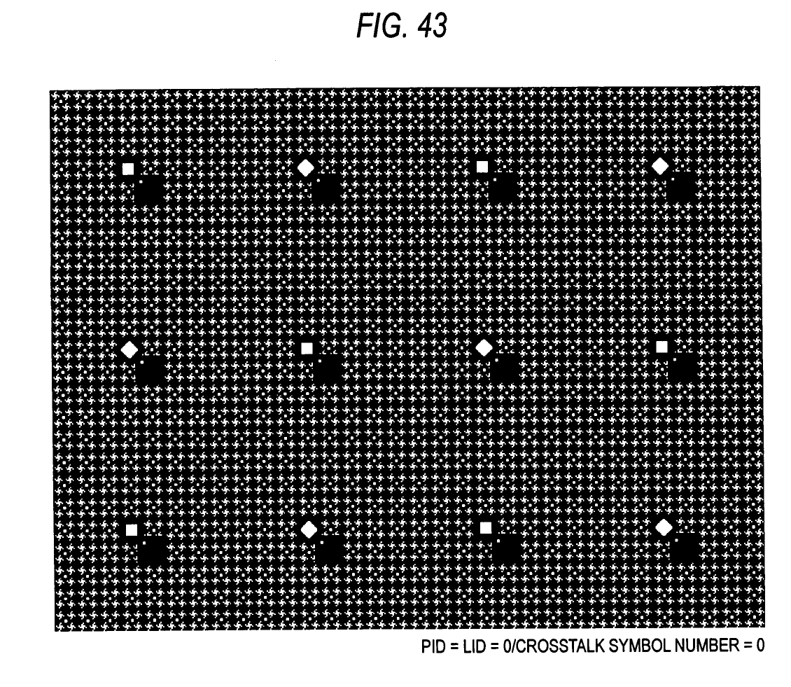

FIG. 43 shows exemplary 00h fixed data modification.

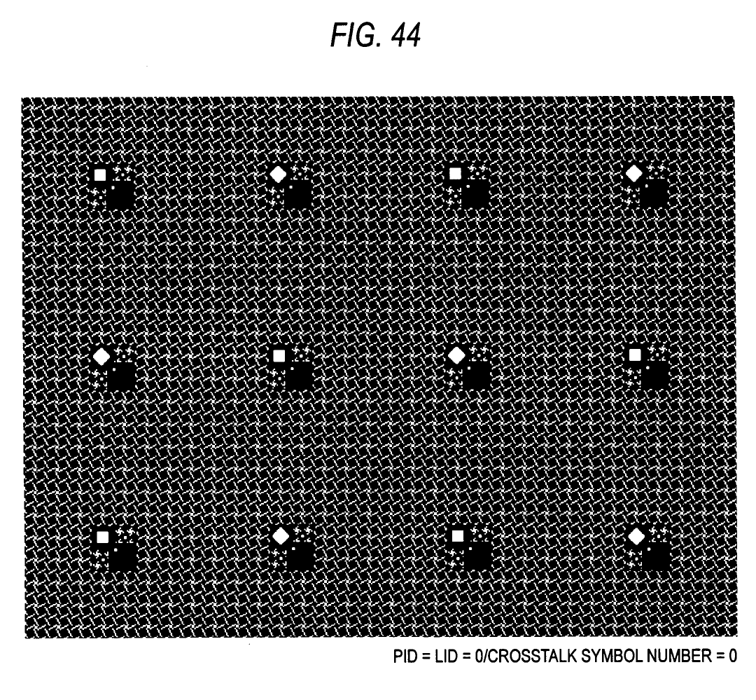

FIG. 44 shows exemplary FFh fixed data modification.

As shown in FIG. 1A, the physical pages like these are sequentially displayed on the liquid crystal panel 1, the object beams L2 interfere with the record reference beams L3 to be an image of the physical pages, and the interference fringes are recorded as a single element hologram. The individual physical pages are sequentially recorded as element holograms to form element holograms on the plane of a hologram material as depicted by black circles in FIG. 45. As described above, the hologram unit matrix is formed in which the element holograms are arranged two-dimensionally.

Subsequently, the main sync symbols formed in the synchronization signal creation process D3 shown in FIG. 24 will be described. As described above, in the main sync symbols included in the page search symbol, the two-dimensional patterns are separately used for the even numbered group main-sync and for the odd numbered group main-sync.

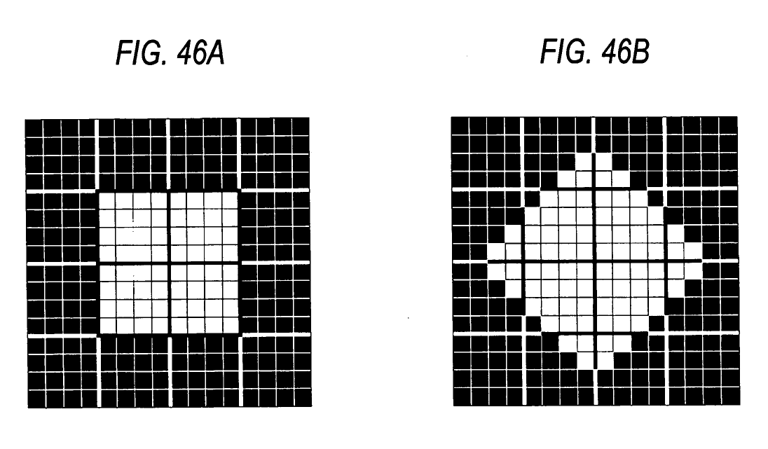

FIG. 46A shows a main sync symbol added to the even numbered group main-sync, and FIG. 46B shows a main sync symbol added to the odd numbered group main-sync.

The main sync symbol for the even numbered group main-sync shown in FIG. 46A is a pattern in which 8×8 center pixels are the white level and all the pixels there around are the black level in 16×16 pixels of a two-dimensional pattern.

The main sync symbol for the odd numbered group main-sync shown in FIG. 46B is a pattern in which the pixels of the white level are allocated at the center so as to form a rhombus similarly in 16×16 pixels of a two-dimensional pattern.

As described above, the main sync symbols are configured of a group of white level pixels in the size greater than 4×4 pixels of a 2D code symbol.

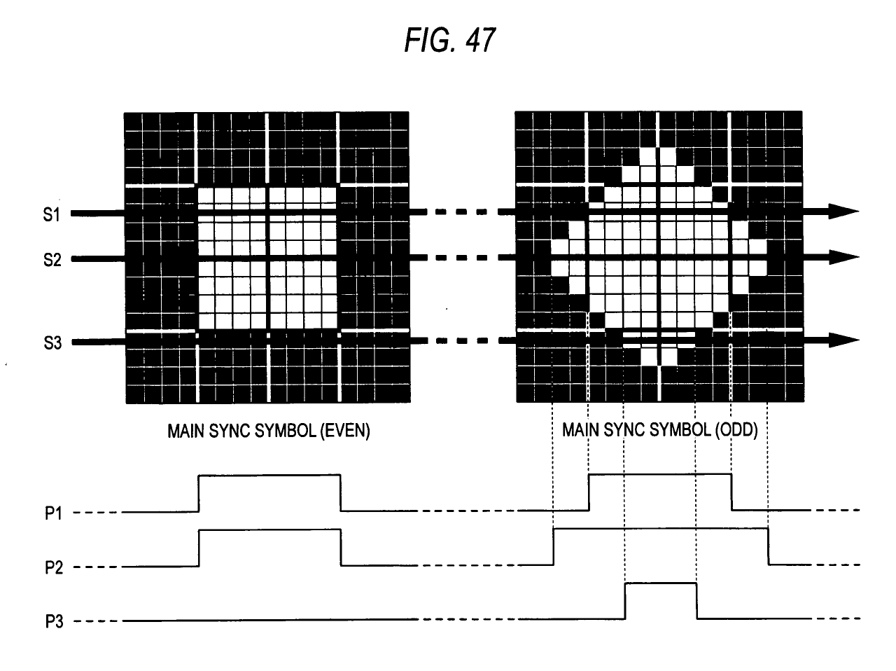

FIG. 47 shows reconstruction waveforms for the odd numbered and the even numbered main sync symbols. In FIG. 47, scanning paths S1, S2 and S3 are shown as the paths to which the reconstruction reference beams L4 are applied in reconstruction, and reconstruction waveforms P1, P2 and P3 are shown which are reconstruction waveforms (detection waveforms for black and white patterns) and are obtained as corresponding to the scanning paths S1, S2 and S3. For the reconstruction waveform, high level signals are obtained with respect to the white level pixels.

As apparent from the drawing, depending on the patterns of the odd numbered and the even numbered main sync symbols, different reconstruction waveforms are obtained in accordance with scan positions. In other words, the high level width of the reconstruction waveform for each of the main sync symbols is determined to easily detect the reconstruction position (the scan position) for the recorded pattern.

In addition, for the main sync symbols, two types of examples are taken shown in FIGS. 46A and 46B, but this scheme may be done in which three types or more of main sync symbols are set and assigned to the individual groups main-sync. In addition, the two-dimensional patterns for the main sync symbols are not limited to the patterns shown in FIGS. 46A and 46B. It is sufficient that pattern types for the individual groups main-sync are set as the two-dimensional patterns to obtain different reconstruction waveforms depending on the scanning path, as described above.

Next, the physical page ID code symbol and the logical page ID code symbol will be described, which are created in the page ID creation process D1, the page ID encoding process D2, and the two-dimensional modification process D5 shown in FIG. 24.

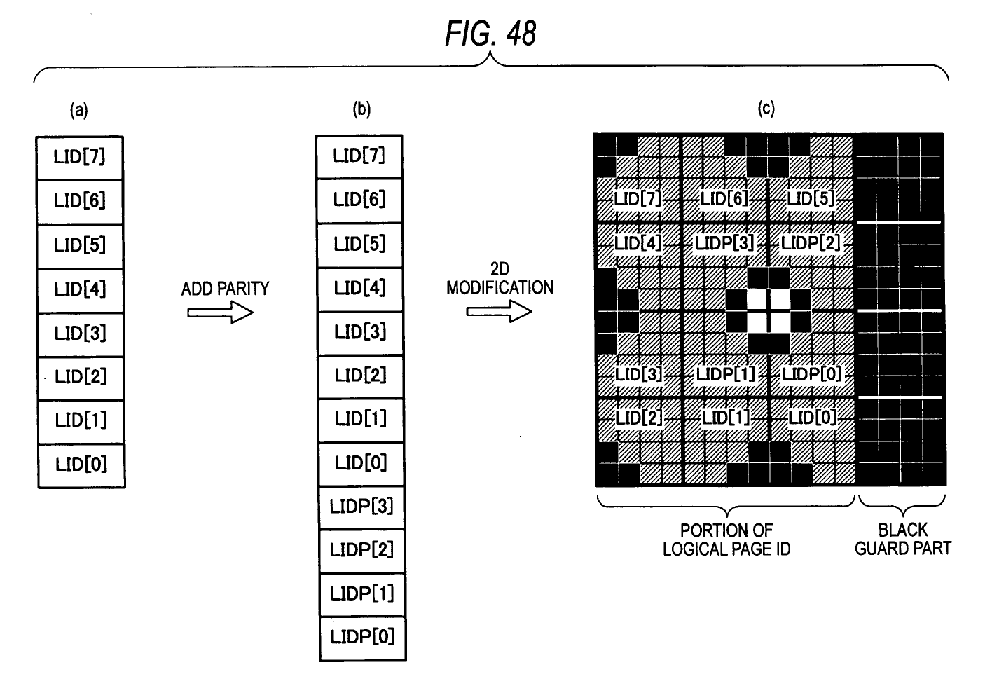

FIG. 48 shows the process for the logical page ID. The logical page ID is an identification number uniquely assigned to the inner encoded pages IEP (IEP[0], IEP[1], . . . , IEP[ef−1]) and to the outer parity pages OPP (OPP[0], . . . , OPP[eg−1]) configuring the code page block shown in FIG. 20 before the page duplication process C3 is conducted in the outer page encoder 13.

(a) in FIG. 48 shows an exemplary logical page ID, showing that eight bytes of a unique address are added in the example. LID[0], . . . , LID[7] each show one byte value configuring the logical page ID. In the page ID creation process D1, eight bytes of the address value, LID[0], . . . , LID[7], are created.

In the page ID encoding process D2, a parity is added to eight bytes of the address value. (b) in FIG. 48 shows an example in which four bytes of a parity (LIDP[0], . . . , LIDP[3) are added to eight bytes of the logical page ID for error detection and correction.

In the two-dimensional modification process D5, the logical page ID code added with the parity is converted into a logical page ID code symbol. (c) in FIG. 48 shows a logical page ID code symbol.

The value of each of bytes LID[0], . . . , LID[7] and LIDP[0], . . . , LIDP[3] is each converted into two-dimensional patterns in accordance with the value in 4×4 pixels of 16 pixels, and arranged in the portion of the logical page ID as an area of 12 pixels in row and 16 pixels in column. In addition, as shown in the drawing, the area for four symbols at the right end, the area of four pixels in row and 16 pixels in column, is a black guard part in which all the pixels are at the black level. The black guard part is an area which secures the symbol space to a crosstalk detect symbol adjacent thereto as shown in FIG. 37.

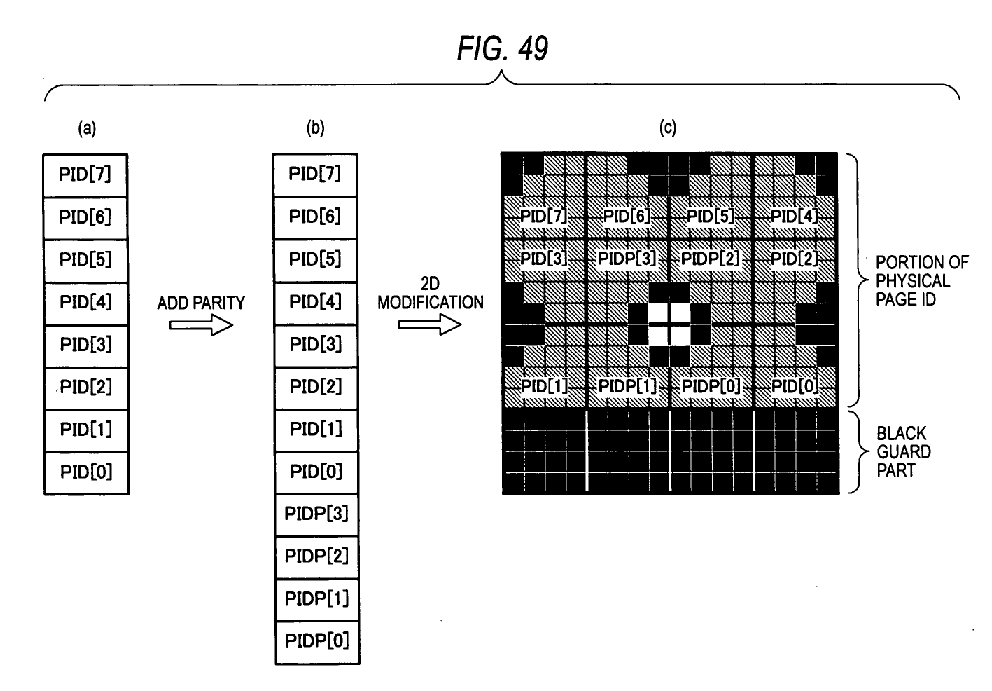

FIG. 49 shows the process for the physical page ID. The physical page ID is an identification number uniquely assigned to the inner encoded pages IEP (IEP[0], IEP[1], . . . , IEP[ef−1]) and to the outer parity pages OPP (OPP[0], . . . , pp[eg−1]) configuring the duplicated page block shown in FIG. 21 after the page duplication process C3 is conducted in the outer page encoder 13.

More specifically, even though pages are logically identical pages, the pages copied by the page duplication process C3 are added with physical page IDs separately.

(a) in FIG. 49 shows an exemplary physical page ID, showing that eight bytes of a unique address are added in the example. PID[0], . . . , PID[7] each show the byte value configuring the physical page ID. In the page ID creation process D1, eight bytes of the address value PID[0], . . . , PID[7] are created.

In the page ID encoding process D2, a parity is added to eight bytes of the address value. (b) in FIG. 49 shows an example in which a parity (PIDP[0], . . . , PIDP[3]) is added to eight bytes of the physical page ID for four bytes of error detection and correction.

In the two-dimensional modification process D5, the physical page ID code added with the parity is converted into a physical page ID code symbol. (c) in FIG. 49 shows a physical page ID code symbol.

The value of each of bytes PID[], . . . , PID[7] and PIDP[0], . . . , PIDP[3] is each converted into two-dimensional patterns in accordance with the value in 4×4 pixels of 16 pixels, and arranged in the portion of the physical page ID as an area of 16 pixels in row and 12 pixels in column. In addition, as shown in the drawing, the area for four symbols at the lower end, the area of 16 pixels in row and four pixels in column, is a black guard part in which all the pixels are at the black level. The black guard part is an area which secures the symbol space to a crosstalk detect symbol adjacent thereto as shown in FIG. 37.

Next, the crosstalk detect symbol will be described, which is created in the crosstalk detect symbol creation process D4 shown in FIG. 24.

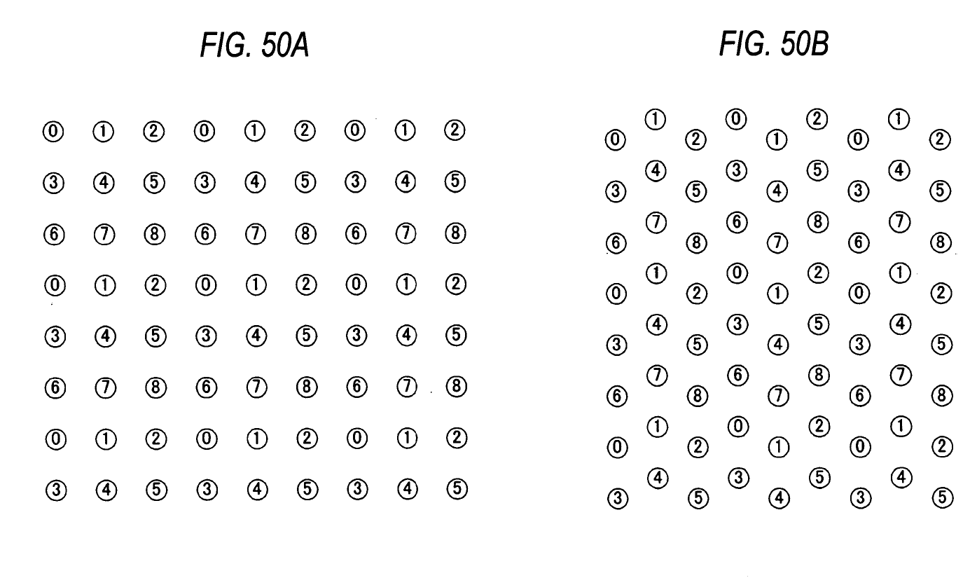

FIGS. 50A and 50B show rules to embed a crosstalk detect symbol number into each of the element holograms arranged as a hologram unit matrix. In FIGS. 50A and 50B, a single element hologram is depicted as a white circle, and in the circle, a crosstalk detect symbol number is depicted as a number. The crosstalk detect symbol number represents types of patterns of crosstalk detect symbols.

First, for arrangement methods of the element holograms, two types of patterns can be considered: a square pattern in FIG. 50A, and a staggered pattern in FIG. 50B. To the two-dimensional arrangements , nine types of crosstalk detect symbol numbers “0” to “8” are allocated as shown in FIG. 50A gand 50B.

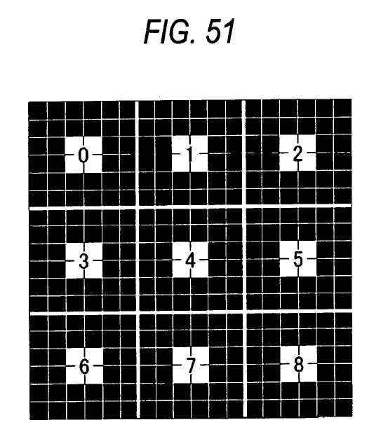

FIG. 51 shows a crosstalk detect symbol. The crosstalk detect symbol is configured in a form of 18 pixels in row×18 pixels in column.

In addition, as apparent from FIG. 37, the pixels in two rows at the upper end, 16 pixels in row×2 pixels in column, and the pixels at the left end, of 2 pixels in row×16 pixels in column in the crosstalk detect symbol are overlapped with the black guard parts of the logical page ID code symbol and the physical page ID code symbol, and thus the page search symbol is a pattern of 32×32 pixels.

The area of 18 pixels in row×18 pixels in column described above has nine areas in total, three areas in row × three areas in column, as one area has 6 pixels×6 pixels.

The crosstalk detect symbol shown in FIG. 51 has four center pixels in nine of 6×6 pixel areas established as the white level among the pixels of 18 pixels in row×18 pixels in column, depicting crosstalk detect symbol numbers.

A crosstalk detect symbol number is allocated to a single element hologram as shown in FIGS. 50A and 50B. In the pattern shown in FIG. 51, for the crosstalk detect symbol, only four pixels in the area corresponding to the crosstalk detect symbol number is set to the white level, and all the other numbers are set to the black level.

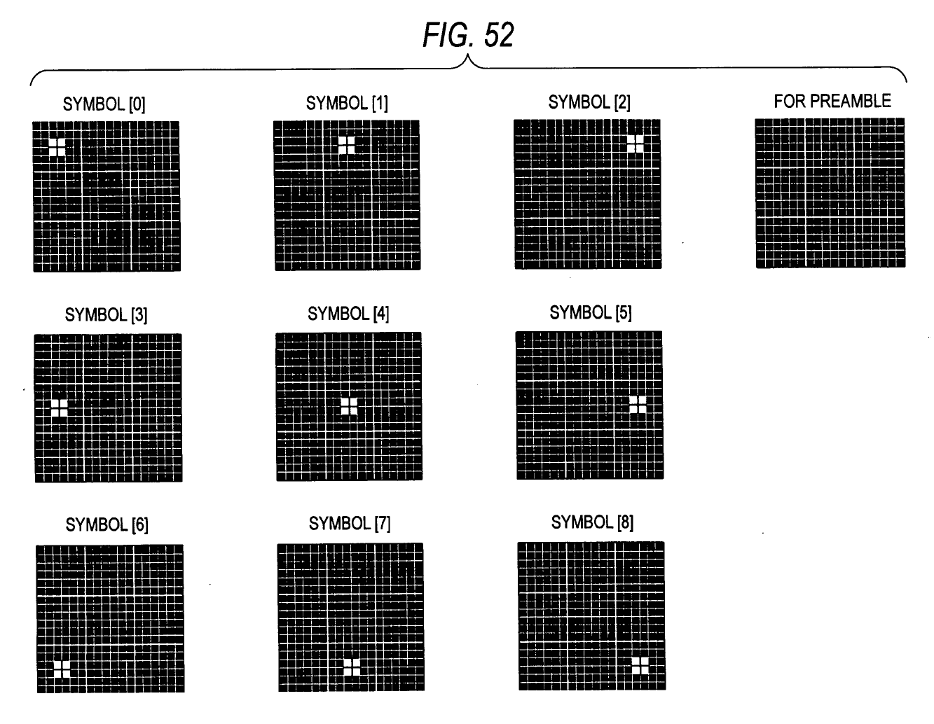

FIG. 52 shows nine types of crosstalk detect symbols, crosstalk detect symbol numbers “0” to “8”.

For example, a crosstalk detect symbol having a crosstalk detect symbol number “0” (Symbol[0]) has a pattern of 18 pixels in row×18 pixels in column in which only four pixels shown in “0” in FIG. 51 are at the white level and all the others are at the black level.

In addition, a crosstalk detect symbol having a crosstalk detect symbol number “1” (Symbol[1]) has a pattern of 18 pixels in row×18 pixels in column in which only four pixels shown in “1” in FIG. 51 are at the white level and all the others are at the black level.

In addition, FIG. 52 also shows a crosstalk detect symbol to be added to a special page such as a preamble. The crosstalk detect symbol added to the preamble has a pattern in which all the pixels are at the black level.

As described above, in the crosstalk detect symbol creation process D4, the crosstalk detect symbols are created as a two-dimensional pattern having three areas in column x three areas in row (one area=6×6 pixels), nine areas in total. Particularly, such a two-dimensional pattern is formed that one area is the area including pixels at the white level, and the other areas are the areas including pixels at the black level among nine areas.

Then, by establishing the area including the pixels at the white level among nine areas, nine types of the crosstalk detect symbols, crosstalk detect symbol numbers “0” to “8”, are established.

In the crosstalk detect symbol creation process D4, the crosstalk detect symbols of individual numbers are outputted in a predetermined order so as to include the crosstalk detect symbols having the numbers allocated among a plurality of types of the crosstalk detect symbols (the crosstalk detect symbol numbers “0” to “8”) depending on the positions of the element holograms among the individual element holograms arranged in the element hologram matrixing process D7.

In addition, the crosstalk detect symbols of individual numbers are outputted in a predetermined order in such a way that different types of crosstalk detect symbols are given to the adjacent element holograms.

The method of using the crosstalk detect symbols will be described as examples are taken.

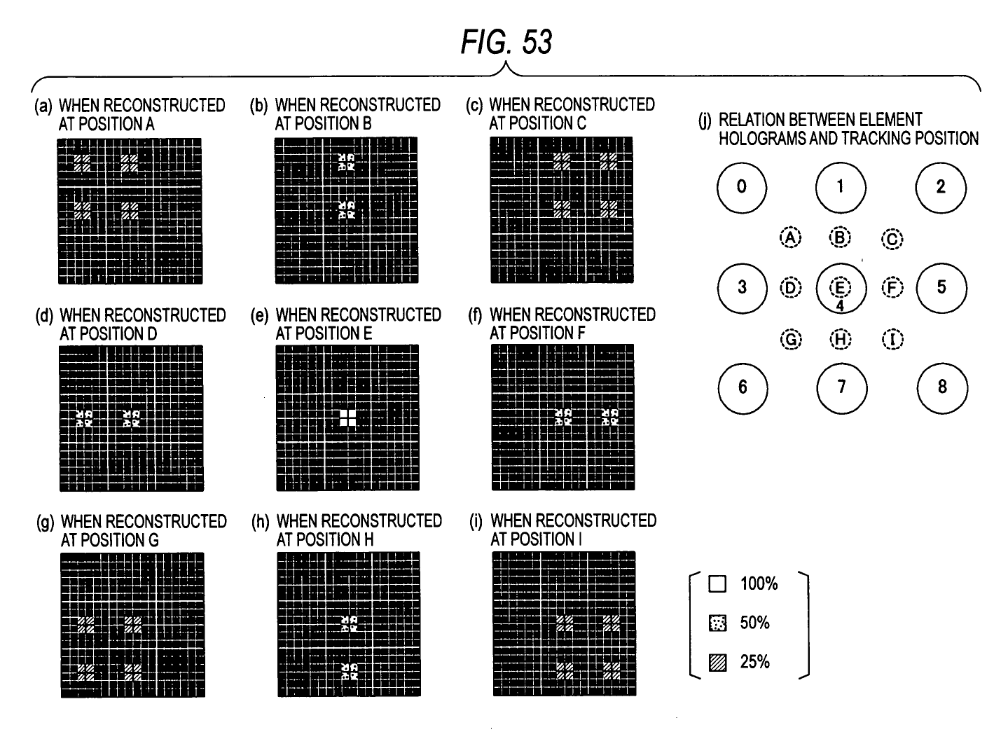

FIG. 53 shows exemplary reconstructed images of crosstalk detect symbols when element holograms are arranged in a square pattern as shown in FIG. 50A. In (j) in FIG. 53, a white circle depicts an element hologram, and a number in the white circle depicts a crosstalk detect symbol number allocated to that element hologram. In addition, circles A to I encircled by a dotted line depict tracking positions in reconstruction, that is, the center of the spot of the reconstruction reference beams L4.

This is exemplary tracking that the element hologram of a crosstalk detect symbol number 4 is centered.

When reconstruction is made at a tracking position A shown in (j) in FIG. 53, reconstruction is made for the middle positions among four element holograms allocated with crosstalk detect symbol numbers 0, 1, 3 and 4. Therefore, as shown in (a) in FIG. 53, the reconstructed image of the crosstalk detect symbols is the reconstructed image in which the crosstalk detect symbols of the crosstalk detect symbol numbers 0, 1, 3 and 4 are synthesized, and the white level portions corresponding to the crosstalk detect symbol numbers 0, 1, 3 and 4 are each detected at 25% of intensity.

When reconstruction is made at a tracking position B shown in (j) in FIG. 53, reconstruction is made for the middle positions between two element holograms of crosstalk detect symbol numbers 1 and 4. Therefore, as shown in (b) in FIG. 53, the reconstructed image of the crosstalk detect symbols is the reconstructed image in which the crosstalk detect symbols of the crosstalk detect symbol numbers 0 and 4 are synthesized, and the white level portions corresponding to the crosstalk detect symbol numbers 0 and 4 are each detected at 50% of intensity.

When reconstruction is made at a tracking position C shown in (j) in FIG. 53, reconstruction is made for the middle positions among four element holograms of crosstalk detect symbol numbers 1, 2, 4 and 5. Therefore, as shown in (c) in FIG. 53, in the reconstructed image of the crosstalk detect symbols, the white level portions corresponding to the crosstalk detect symbol numbers 1, 2, 4 and 5 are each detected at 25% of intensity.

When reconstruction is made at a tracking position D shown in (j) in FIG. 53, reconstruction is made for the middle positions between two element holograms of crosstalk detect symbol numbers 3 and 4. Therefore, as shown in (d) in FIG. 53, in the reconstructed image of the crosstalk detect symbols, the white level portions corresponding to the crosstalk detect symbol numbers 3 and 4 are each detected at 50% of intensity.

When reconstruction is made at a tracking position E shown in (j) in FIG. 53, reconstruction is made for the position right above the element hologram of the crosstalk detect symbol number 4. Therefore, as shown in (e) in FIG. 53, in the reconstructed image of the crosstalk detect symbols, the white level portion corresponding to the crosstalk detect symbol number 4 is detected at 100% of intensity.

Similarly, when reconstruction is made at a tracking position F shown in (j) in FIG. 53, as shown in (f) in FIG. 53, the white level portions corresponding to the crosstalk detect symbol numbers 4 and 5 are each detected at 50% of intensity.

When reconstruction is made at a tracking position G shown in (j) in FIG. 53, as shown in (g) in FIG. 53, the white level portions corresponding to the crosstalk detect symbol numbers 3, 4, 6 and 7 are each detected at 25% of intensity.

When reconstruction is made at a tracking position H shown in (j) in FIG. 53, as shown in (h) in FIG. 53, the white level portions corresponding to the crosstalk detect symbol numbers 4 and 7 are each detected at 50% of intensity.

When reconstruction is made at a tracking position I shown in (j) in FIG. 53, as shown in (i) in FIG. 53, the white level portions corresponding to the crosstalk detect symbol numbers 4, 5, 7 and 8 are each detected at 25% of intensity.

As described above, the relation between the element hologram matrix and the tracking positions is reflected in the reconstructed image of the crosstalk detect symbols.

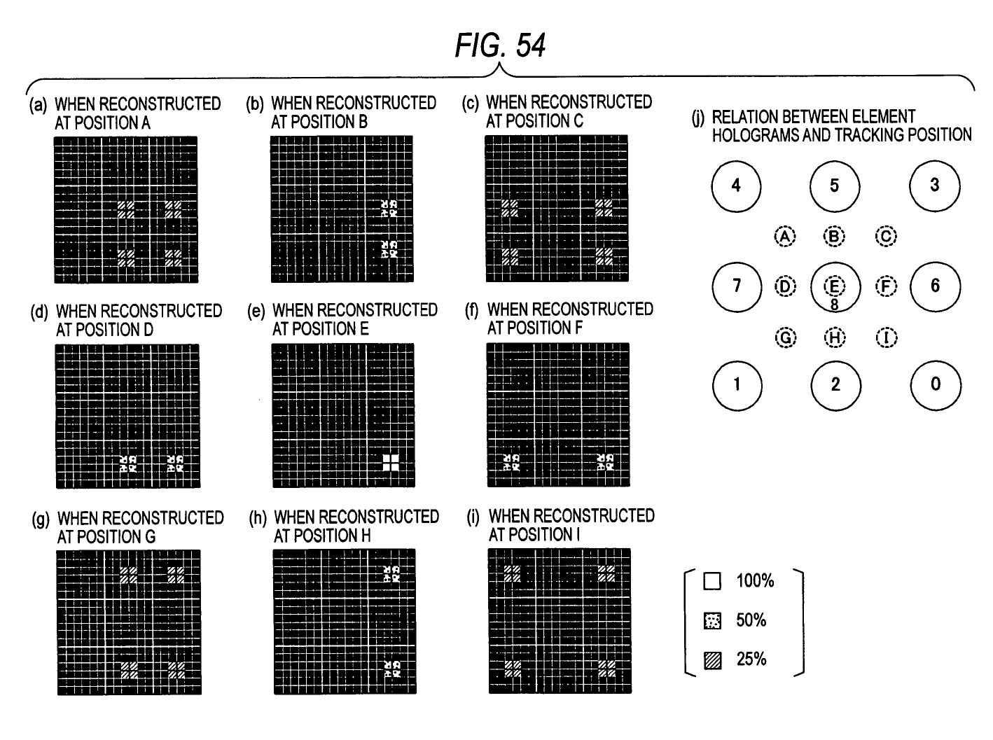

FIG. 54 similarly shows exemplary reconstruction images of crosstalk detect symbols in which element holograms are arranged in the square pattern as shown in FIG. 50A. This is exemplary tracking as an element hologram of a crosstalk detect symbol number 8 is centered.

When reconstruction is made at a tracking position A shown in (j) in FIG. 54, reconstruction is made for the middle positions among four element holograms allocated with crosstalk detect symbol numbers 4, 5, 7 and 8. Therefore, as shown in (a) in FIG. 53, the reconstructed image of the crosstalk detect symbols is the reconstructed image in which the crosstalk detect symbols of the crosstalk detect symbol numbers 4, 5, 7 and 8 are synthesized, and the white level portions corresponding to the crosstalk detect symbol numbers 4, 5, 7 and 8 are each detected at 25% of intensity.

When reconstruction is made at a tracking position B shown in (j) in FIG. 54, reconstruction is made for the middle positions between two element holograms of crosstalk detect symbol numbers 5 and 8. Therefore, as shown in (b) in FIG. 54, in the reconstructed image of the crosstalk detect symbols, the white level portions corresponding to the crosstalk detect symbol numbers 5 and 8 are each detected at 50% of intensity.

When reconstruction is made at a tracking position C shown in (j) in FIG. 54, reconstruction is made for the middle positions among four element holograms allocated with crosstalk detect symbol numbers 5, 3, 8 and 6. Therefore, as shown in (c) in FIG. 54, in the reconstructed image of the crosstalk detect symbols, the white level portions corresponding to the crosstalk detect symbol numbers 5, 3, 8 and 6 are each detected at 25% of intensity.

When reconstruction is made at a tracking position D shown in (j) in FIG. 54, reconstruction is made for the middle portions between two element holograms of crosstalk detect symbol numbers 7 and 8. Therefore, as shown in (d) in FIG. 54, in the reconstructed image of the crosstalk detect symbols, the white level portions corresponding to the crosstalk detect symbol numbers 7 and 8 are each detected at 50% of intensity.

When reconstruction is made at a tracking position E shown in (j) in FIG. 54, reconstruction is made for the position right above the element hologram of the crosstalk detect symbol number 8. Therefore, as shown in (e) in FIG. 54, in the reconstructed image of the crosstalk detect symbols, the white level portion corresponding to the crosstalk detect symbol number 8 is detected at 100% of intensity.

Similarly, when reconstruction is made at a tracking position F shown in (j) in FIG. 54, as shown in (f) in FIG. 54, the white level portions corresponding to the crosstalk detect symbol numbers 8 and 6 are each detected at 50% of intensity.

When reconstruction is made at a tracking position G shown in (j) in FIG. 54, as shown in (g) in FIG. 54, the white level portions corresponding to the crosstalk detect symbol numbers 7, 8, 1 and 2 are each detected at 25% of intensity.

When reconstruction is made at a tracking position H shown in (j) in FIG. 54, as shown in (h) in FIG. 54, the white level portions corresponding to the crosstalk detect symbol numbers 8 and 2 are each detected at 50% of intensity.

When reconstruction is made at a tracking position I shown in (j) in FIG. 54, as shown in (i) in FIG. 54, the white level portions corresponding to the crosstalk detect symbol numbers 8, 6, 2 and 0 are each detected at 25% of intensity.

As described above, the relation between the element hologram matrix and the tracking positions is reflected in the reconstructed image of the crosstalk detect symbols.

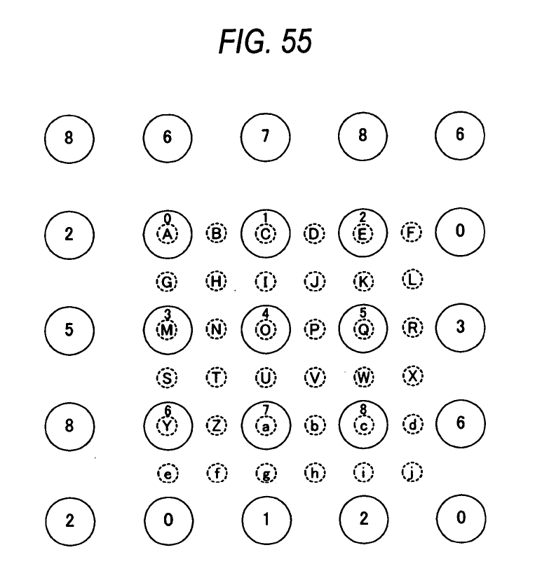

FIG. 55 shows a typical example of tracking for an element hologram matrix in the square pattern, including some cases other than the tracking positions as the element holograms of the crosstalk detect symbol numbers 4 and 8 are centered shown in FIGS. 53 and 54 as described above.

Similarly in FIG. 55, crosstalk detect symbol numbers are depicted by numbers in white circles of element holograms. In addition, the tracking positions are depicted as a circle of a dotted line shown by A to Z and a to j.

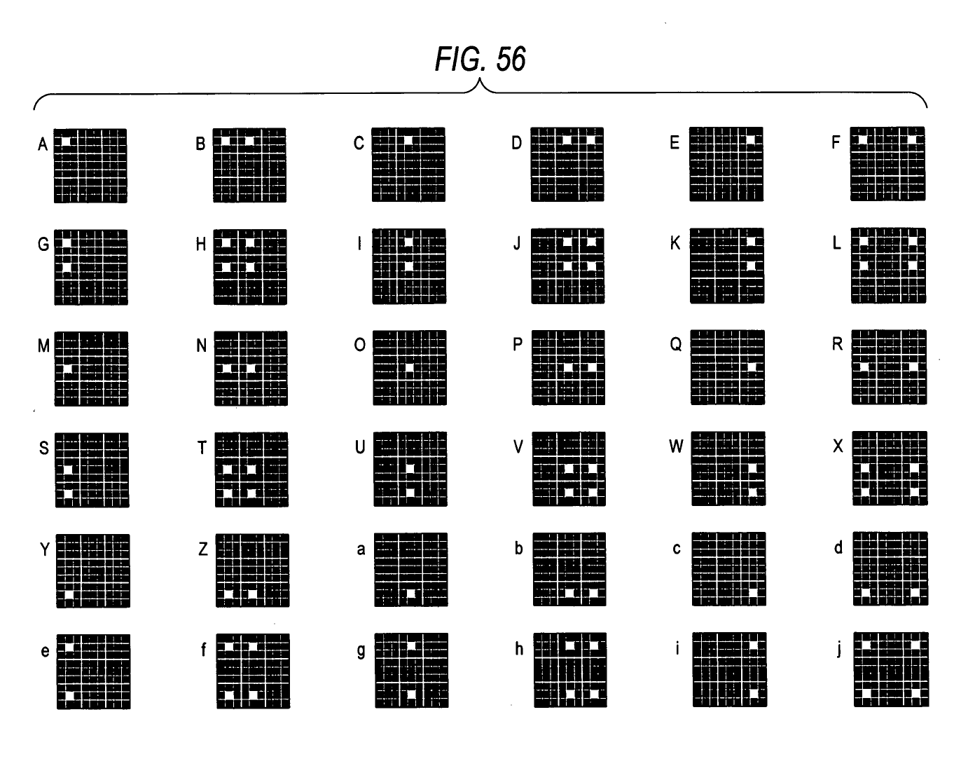

For the typical example of tracking, two cases are considered: the case in which reconstruction is made for right above an element hologram (just tracking), and the case in which reconstruction is made for the middle positions between a plurality of element holograms (half tracking). As shown in FIG. 55, there are 36 ways of tracking conditions, A to Z and a to j. FIG. 56 shows reconstruction images of 36 ways of the tracking conditions.

Although specific explanations at the tracking positions are omitted, for similar understanding as in the cases in FIGS. 53 and 54, when reconstruction is made right above a certain element hologram, in the reconstructed image of the crosstalk detect symbols, the white level portion corresponding to a crosstalk detect symbol number allocated to that element hologram is detected at 100% of intensity. In addition, in the half tracking condition for two element holograms, in the reconstructed image of the crosstalk detect symbols, the white level portions corresponding to two crosstalk detect symbol numbers allocated to those two element holograms are each detected at 50% of intensity. In addition, in the half tracking condition for four element holograms, in the reconstructed image of the crosstalk detect symbols, the white level portions corresponding to four crosstalk detect symbol numbers allocated to those four element holograms are each detected at 50% of intensity.

In addition, in reality, there is also a delicate intermediate condition between the just tracking condition and the half tracking conditions. In this case, the condition appears as the balance in the intensity of the white level portions in the crosstalk detect symbol.

Next, the reconstructed images of the crosstalk detect symbols will be described when the element holograms are arranged in the staggered pattern as shown in FIG. 50B.

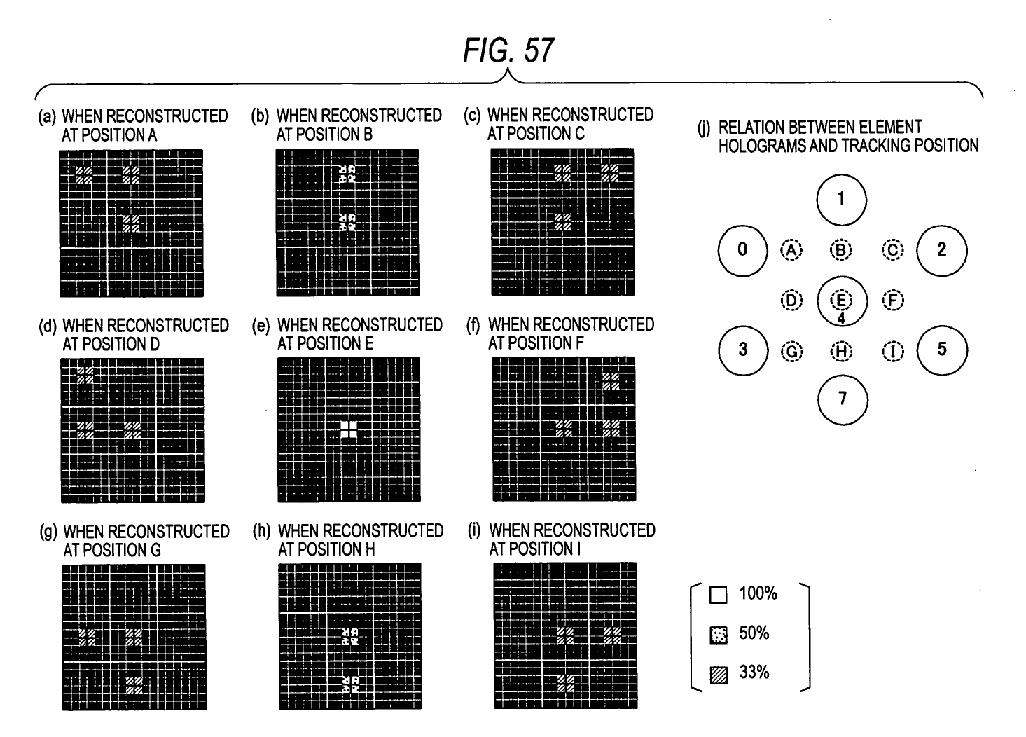

In (j) in FIG. 57, the element holograms arranged in the staggered pattern are depicted by a white circle, showing crosstalk detect symbol numbers allocated by numbers. In addition, circles A to I in a dotted line depict tracking positions. FIG. 57 shows exemplary tracking as the even numbered element hologram of a crosstalk detect symbol number 4 is centered.

When reconstruction is made at a tracking position A shown in (j) in FIG. 57, reconstruction is made for the middle positions among three element holograms allocated with crosstalk detect symbol numbers 0, 1 and 4. Therefore, as shown in (a) in FIG. 57, the reconstructed image of the crosstalk detect symbols is the reconstructed image in which the crosstalk detect symbols of the crosstalk detect symbol numbers 0, 1 and 4 are synthesized, and the white level portions corresponding to the crosstalk detect symbol numbers 0, 1 and 4 are each detected at 33% of intensity.

When reconstruction is made at a tracking position B shown in (j) in FIG. 57, reconstruction is made for the middle positions between two element holograms allocated with crosstalk detect symbol numbers 1 and 4. Therefore, as shown in (b) in FIG. 57, the white level portions corresponding to the crosstalk detect symbol numbers 1 and 4 are each detected at 50% of intensity.

When reconstruction is made at a tracking position C shown in (j) in FIG. 57, reconstruction is made for the middle positions among three element holograms allocated with crosstalk detect symbol numbers 1, 2 and 4. Therefore, as shown in (c) in FIG. 57, in the reconstructed image of the crosstalk detect symbols, the white level portions corresponding to the crosstalk detect symbol numbers 1, 2 and 4 are each detected at 33% of intensity.

When reconstruction is made at a tracking position D shown in (j) in FIG. 57, reconstruction is made for the middle positions among three element holograms allocated with crosstalk detect symbol numbers 0, 3 and 4. Therefore, as shown in (d) in FIG. 57, in the reconstructed image of the crosstalk detect symbols, the white level portions corresponding to the crosstalk detect symbol numbers 0, 3 and 4 are each detected at 33% of intensity.

When reconstruction is made at a tracking position E shown in (j) in FIG. 57, reconstruction is made for the position right above an element hologram of the crosstalk detect symbol number 4. Therefore, as shown in (e) in FIG. 57, in the reconstructed image of the crosstalk detect symbols, the white level portion corresponding to the crosstalk detect symbol number 4 is detected at 100% of intensity.

Similarly, when reconstruction is made at a tracking position F shown in (j) in FIG. 57, as shown in (f) in FIG. 57, the white level portions corresponding to the crosstalk detect symbol numbers 2, 4 and 5 are each detected at 33% of intensity.

When reconstruction is made at a tracking position G shown in (j) in FIG. 57, as shown in (g) in FIG. 57, the white level portions corresponding to the crosstalk detect symbol numbers 4, 3 and 7 are each detected at 33% of intensity.

When reconstruction is made at a tracking position H shown in (j) in FIG. 57, as shown in (h) in FIG. 57, the white level portions corresponding to the crosstalk detect symbol numbers 4 and 7 are each detected at 50% of intensity.

When reconstruction is made at a tracking position I shown in (j) in FIG. 57, as shown in (i) in FIG. 57, the white level portions corresponding to the crosstalk detect symbol numbers 4, 5 and 7 are each detected at 33% of intensity.

As described above, the relation between the element hologram matrix and the tracking positions is reflected in the reconstructed image of the crosstalk detect symbols.

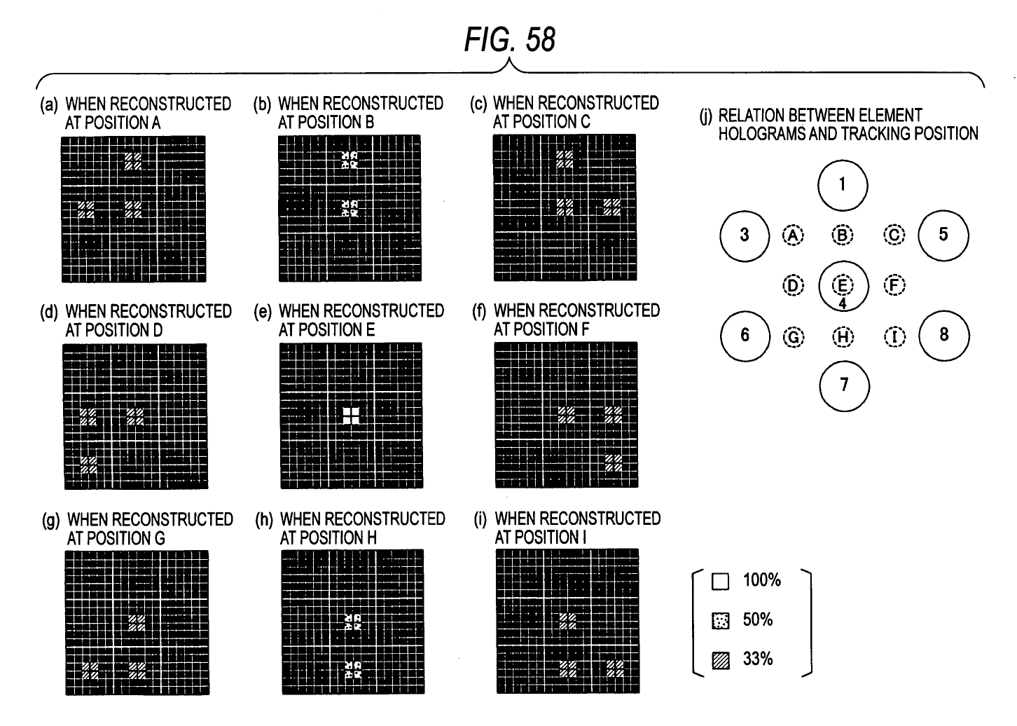

FIG. 58 similarly shows exemplary reconstructed images when an odd numbered element hologram of a crosstalk detect symbol number 4 is centered in the staggered pattern arrangement.

When reconstruction is made at a tracking position A shown in (j) in FIG. 58, reconstruction is made for the middle positions among three element holograms allocated with crosstalk detect symbol numbers 1, 3 and 4. Therefore, as shown in (a) in FIG. 58, the reconstructed image of the crosstalk detect symbols is the reconstructed image in which the crosstalk detect symbols of the crosstalk detect symbol numbers 1, 3 and 4 are synthesized, and the white level portions corresponding to the crosstalk detect symbol numbers 1, 3 and 4 are each detected at 33% of intensity.

When reconstruction is made at a tracking position B shown in (j) in FIG. 58, reconstruction is made for the middle positions between two element holograms allocated with crosstalk detect symbol numbers 1 and 4. Therefore, as shown in (b) in FIG. 58, in the reconstructed image of the crosstalk detect symbols, the white level portions corresponding to the crosstalk detect symbol numbers 1 and 4 are each detected at 50% of intensity.

When reconstruction is made at a tracking position C shown in (j) in FIG. 58, reconstruction is made for the middle positions among three element holograms allocated with crosstalk detect symbol numbers 1, 5 and 4. Therefore, as shown in (c) in FIG. 58, in the reconstructed image of the crosstalk detect symbols, the white level portions corresponding to the crosstalk detect symbol numbers 1, 5 and 4 are each detected at 33% of intensity.

When reconstruction is made at a tracking position D shown in (j) in FIG. 58, reconstruction is made for the middle positions among three element holograms allocated with crosstalk detect symbol numbers 3, 4 and 6. Therefore, as shown in (d) in FIG. 58, in the reconstructed image of the crosstalk detect symbols, the white level portions corresponding to the crosstalk detect symbol numbers 3, 4 and 6 are each detected at 33% of intensity.

When reconstruction is made at a tracking position E shown in (j) in FIG. 58, reconstruction is made for the position right above the element hologram of the crosstalk detect symbol number 4. Therefore, as shown in (e) in FIG. 58, in the reconstructed image of the crosstalk detect symbols, the white level portion corresponding to the crosstalk detect symbol number 4 is detected at 100% of intensity.

Similarly, when reconstruction is made at a tracking position F shown in (j) in FIG. 58, as shown in (f) in FIG. 58, the white level portions corresponding to the crosstalk detect symbol numbers 5, 4 and 8 are each detected at 33% of intensity.

When reconstruction is made at a tracking position G shown in (j) in FIG. 58, as shown in (g) in FIG. 58, the white level portions corresponding to the crosstalk detect symbol numbers 4, 6 and 7 are each detected at 33% of intensity.

When reconstruction is made at a tracking position H shown in (j) in FIG. 58, as shown in (h) in FIG. 58, the white level portions corresponding to the crosstalk detect symbol numbers 4 and 7 are each detected at 50% of intensity.

When reconstruction is made at a tracking position I shown in (j) in FIG. 58, as shown in (i) in FIG. 58, the white level portions corresponding to the crosstalk detect symbol numbers 4, 8 and 7 are each detected at 33% of intensity.

As described above, the relation between the element hologram matrix and the tracking positions is reflected in the reconstructed image of the crosstalk detect symbols.

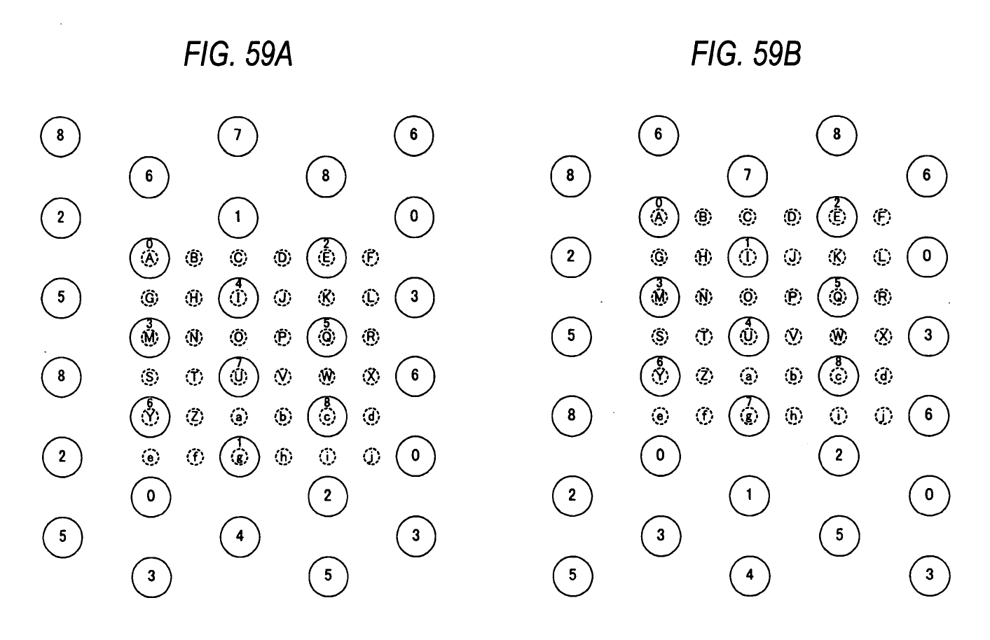

FIGS. 59A and 59B show typical examples of tracking for element hologram matrices in the staggered pattern. In the case of the staggered pattern, it is divided into two cases: an odd column and an even column. As shown in FIG. 59A, in the case of the odd column, the column of the element holograms allocated with the crosstalk detect symbol numbers 1, 4 and 7 is shifted upward by 0.5 of an element hologram from the column of the crosstalk detect symbol numbers 0, 3 and 6 and from the column of the crosstalk detect symbol numbers 2, 5 and 8, and as shown in FIG. 59B, in the case of even column, the column is shifted downward by 0.5 of an element hologram.

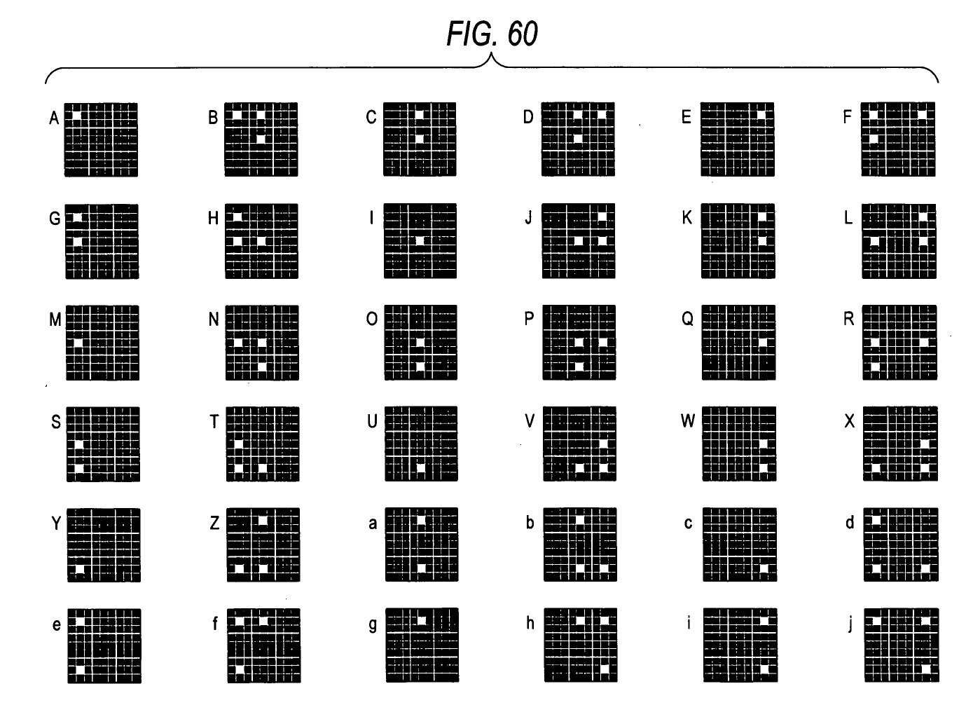

FIG. 60 shows reconstruction images of 36 ways of tracking conditions A to Z and a to j in the case of the odd column shown in FIG. 59A.

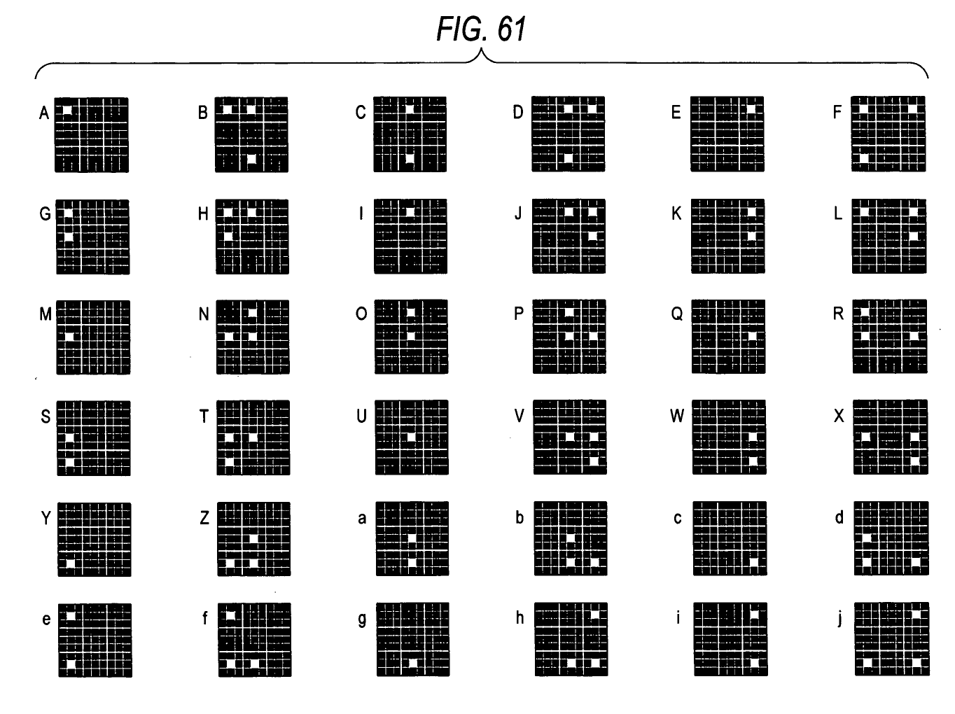

In addition, FIG. 61 shows reconstruction images of 36 ways of tracking conditions A to Z and a to j in the case of the even column shown in FIG. 59B.

For similar understanding as in the cases in FIGS. 57 and 58, when reconstruction is made right above a certain element hologram, in the reconstructed image of the crosstalk detect symbols, the white level portion corresponding to a crosstalk detect symbol number allocated to that element hologram is detected at 100% of intensity. In addition, in the half tracking condition for two element holograms, in the reconstructed image of the crosstalk detect symbols, the white level portions corresponding to two crosstalk detect symbol numbers allocated to those two element holograms are each detected at 50% of intensity. In addition, in the half tracking condition for three element holograms, in the reconstructed image of the crosstalk detect symbols, the white level portions corresponding to three crosstalk detect symbol numbers allocated to those three element holograms are each detected at 33% of intensity.

Also in this case, in reality, there is also a delicate intermediate condition between the just tracking condition and the half tracking conditions. In this case, the condition appears as the balance in the intensity of the white level portions in the crosstalk detect symbol.

The crosstalk detect symbols can be used for determining tracking conditions in reconstruction as described above.

Then, as described in FIG. 24, the crosstalk detect symbol, the main sync symbol, the physical page ID code symbol and the logical page ID code symbol are combined to form a page search symbol.

In addition, the page search symbol is combined with the group sub-sync to form a group main-sync. Then, a plurality of groups main-sync is combined to form a physical page, and a single element hologram is formed based on the physical page.

The element holograms are arranged in a two-dimensional matrix to form a hologram unit matrix 20.

7. Advantages of Embodiment

In the embodiment, the following advantages can be obtained.

In the embodiment, a data page is created from input data as a linear information sequence to be an encoding target, and inner encoding and outer encoding are conducted for the data page. After that, a physical page as two-dimensional data is created, and the physical page is formed into an element hologram matrix, whereby an encoding scheme can be implemented which is preferable for information recording on a hologram recording medium.

Particularly, in the sector splitting process A2 and the EDC adding process A3 in the scrambled page data generator 11, data to be element holograms is split into sectors and added with EDC, whereby the reliability of finally corrected data can be determined in units of sectors.

In addition, in the scramble process A4 in the scrambled page data generator 11, the logical page is scrambled to form a state in which the recorded data cannot be easily estimated from the physical page optically read. Thus, the embodiment is preferable in view of the security and copyright protection of contents data and computer data recorded on the hologram memory 3.

In addition, in the data array transform process B1 and the inner page encoding process B2 in the inner page encoder 12, an error correcting code is added to the logical page unit, whereby error detection and correction is allowed in units of logical pages.

In addition, in the inner page interleave process B3, the interleave process is conducted which is completed inside the logical page, whereby symbol errors caused by the intensity fluctuations and geometric shifts in the physical page can be distributed throughout the physical page.

In addition, the interpage encoding process C2 is conducted in the outer page encoder 13 to eliminate the necessity to read all the pages in the reconstruction of the hologram unit matrix 20 (in the reconstruction of the hologram memory 3 on which the hologram unit matrix 20 is formed). For example, in the case in which 16 pages of parity pages are added to 112 pages of logical page pages, when 77.5% of all the logical pages is finished to read, loss correction is conducted for the unread pages, whereby the full reconstruction of all the logical pages is allowed. Therefore, the implementation of efficient scan and improved data read performance in reconstruction can be intended.

In addition, the page duplication process C3 is conducted in the outer page encoder 13 to allow a closed stack element hologram matrix, and thus the read operation of element holograms can be facilitated.

In addition, the page ID creation process D1 conducted in the hologram unit matrix generator 14 adds the logical page ID uniquely allocated to the inner encoded page and the physical page ID uniquely allocated to the outer encoded page. Thus, in the reconstruction of the physical page from the element holograms, the physical reconstruction position can be first grasped by the physical page ID, and the logical reconstruction position can be grasped at which the physical page is developed as the logical page on the RAM on the reconstruction apparatus side.

In addition, in the two-dimensional modification process D6, as shown in FIG. 26, the 2D code symbol is provided with a sub-sync pixel and sub-guard pixels. Moreover, as shown in FIG. 35, sets of four symbols are rotated and joined to form a group R, and as shown in FIG. 36, four groups of groups R form a group sub-sync, whereby 2×2 pixels of a sub-sync pattern can be created from the created 2D symbol according to one kind of two-dimensional modification tables (FIGS. 28 to 34). Depending on the sub-guard pixels, the white level area is clarified as a sub-sync pattern.

Moreover, four groups of the group R configure a group sub-sync. The sub-sync pattern is established at the center, and the main sync symbol is configured of 4×4 symbols. Thus, as apparent from FIG. 38, the position of the synchronization center can be made uniform in the physical page when seen in units of groups sub-sync.

In addition, 30 patterns shown in FIG. 27 are excluded. In other words, in the process of creating the 2D symbol, the transform of such two-dimensional patterns is inhibited in which the white levels continue in column, in row or diagonally. Thus, the two-dimensional run length limitation can be performed to a pattern of six pixels or below, and it can be easily distinguished from the continuous pattern of eight pixels for use in the main sync symbols.

In addition, the page search symbol has the size that is an integral multiple of the group sub-sync. The group sub-sync has 16×16 pixels, and the page search symbol has 32×32 pixels. In other words, the page search symbol has the size of four groups sub-sync. With this configuration, even though the page search symbol is placed at a given symbol position on the group main-sync, the positions of center of gravity of the main sync symbol and the sub-sync pattern can maintain regularity both on the vertical axis and on the horizontal axis.

In addition, as described in FIGS. 46A, 46B and 47, the even numbered main sync symbol is in a square, and the odd numbered main sync symbol is in a rhombus, whereby a shift can be detected easily, the shift from the center of the symbol in the coordinates to read signals scanned in reconstruction.

In addition, as described in FIGS. 50A to 61, the individual element holograms formed in the hologram unit matrix 20 each include the crosstalk detect symbol which corresponds to the position in the matrix. Therefore, depending on information about the crosstalk detect symbols detected in reconstruction, the tracking condition can be determined.

Particularly, the adjacent element holograms are allocated with different crosstalk detect symbol numbers all the time, that is, the adjacent element holograms are established to be different crosstalk detect symbols all the time, whereby the tracking condition in physical page reconstruction can be detected by fluctuations in intensity of the crosstalk detect symbols.

As described above, the embodiment is described. However, the process procedures and patterns described in the embodiment are merely an example. For an embodiment of the invention, various modifications can be considered within the scope of the teachings.

It should be understood by those skilled in the art that various modifications combinations, sub-combinations and alterations may occur depending on design requirements and other factors insofar as they are within the scope of the appended claims or the equivalents thereof.

What is claimed is:

1. A hologram recording apparatus which forms information into element holograms for recording, comprising:
data page generating means for forming a two-dimensional matrix from a linear information sequence that is an encoding target and generates a data page;
inner page encoding means for conducting encoding that is completed in the data page to generate an inner encoded page;
interpage encoding means for conducting encoding over the inner encoded pages to generate an outer encoded page; and
element hologram matrix generating means for forming the outer encoded page into a two-dimensional code symbol, generating a physical page including the two-dimensional code symbol, and continuously forming the physical page into element holograms to generate an element hologram matrix.

2. The hologram recording apparatus according to claim 1, wherein the data page generating means conducts:
a raw page creation process which forms a two-dimensional matrix from a linear information sequence that is an encoding target and generates a raw page;
a sector splitting process which splits the raw page into raw sectors that are units of error detection;
an error detecting code adding process which adds an error detecting code to the raw sector to form sectors with error detecting codes;
a scramble process which scrambles the sectors with error detecting codes to generate scrambled data sectors; and
a page joining process which joins the scrambled data sectors to generate a scrambled data page to output the scrambled data page as a data page.

3. The hologram recording apparatus according to claim 1, wherein the inner page encoding means conducts:
a data array transform process which transforms the data page outputted from the data page generating means to an arrangement that allows multidimensional encoding and generates an information data block;
an inner page encoding process which performs multidimensional encoding for the information data block to generate a code data block;
an inner page interleave process which rearranges the inside of the code data block in accordance with a predetermined rule to generate an interleaved code data block; and
a data array inverse transform process which transforms the interleaved code data block to a page arrangement equivalent to the data page to generate an inner encoded page.

4. The hologram recording apparatus according to claim 1, wherein the interpage encoding means conducts:
a page arrangement transform process which transforms the inner encoded page outputted from the inner page encoding means to a page arrangement that allows interpage encoding and generates an information page block;
an interpage encoding process which performs interpage encoding for the information page block to generate a code page block;
a page duplication process which duplicates the code page block to multiple blocks to generate duplicated page blocks;
an interpage interleave process which rearranges the duplicated page blocks in accordance with a predetermined rule to generate interleaved duplicated blocks; and
a page arrangement retransform process which transforms the interleaved duplicated blocks to a page arrangement equivalent to the inner encoded page to generate an outer encoded page.

5. The hologram recording apparatus according to claim 1, wherein the element hologram matrix generating means conducts:
a first two-dimensional modification process which two-dimensionally modifies the outer encoded page outputted from the interpage encoding means to generate a two-dimensional code symbol;
a page ID creation process which generates a logical page ID for the inner encoded page and generates a physical page ID for the outer encoded page;
a page ID encoding process which adds an error detection correction parity to the logical page ID and the physical page ID to generate a logical page ID code and a physical page ID code;
a second two-dimensional modification process which two-dimensionally modifies the logical page ID code and the physical page ID code to generate a logical page ID code symbol and a physical page ID code symbol;
a synchronization signal creation process which creates a main sync symbol;
a crosstalk detect symbol creation process which creates a crosstalk detect symbol that detects crosstalk between adjacent element holograms;
a page search symbol creation process which joins the logical page code symbol, the physical page code symbol, the main sync symbols and the crosstalk detect symbol to one another to generate a page search symbol;
a physical page creation process which joins the two-dimensional code symbol to the page search symbol to generate a physical page; and
an element hologram matrixing process which continuously forms the physical pages into element holograms to form an element hologram matrix.

6. A hologram recording apparatus which forms information into element holograms for recording, comprising:
a data page generating module which forms a two-dimensional matrix from a linear information sequence that is an encoding target and generates a data page;
an inner page encoding module which conducts encoding that is completed in the data page to generate an inner encoded page;
an interpage encoding module which conducts encoding over the inner encoded pages to generate an outer encoded page; and
an element hologram matrix generating module which forms the outer encoded page into a two-dimensional code symbol, generates a physical page including the two-dimensional code symbol, and continuously forms the physical page into element holograms to generate an element hologram matrix.

7. A hologram recording method which forms information into element holograms for recording, comprising the steps of:
forming a two-dimensional matrix from a linear information sequence that is an encoding target and generating a data page;
conducting encoding that is completed in the data page and generating an inner encoded page;
conducting encoding over the inner encoded pages to generate an outer encoded page; and
forming the outer encoded page into a two-dimensional code symbol to generate a physical page including the two-dimensional code symbol, and continuously forming the physical page into element holograms to generate an element hologram matrix.
